(19) United States
(12) Patent Application Publication
(10) Pub. No.: US 2026/0179404 A1
(43) Pub. Date: Jun. 25, 2026

(54) VEHICLE CLONING DETERMINATION USING GEO-LOCATION DISPARITY

(71) Applicant: International Business Machines Corporation, Armonk, NY (US)

(72) Inventors: Adam Lee Griffin, Cohasset, MN (US); MARCO GERARDO VAZQUEZ MARTIN, Tepatitlán (MX); Amit Vachhani, Wanawadi (IN); JOBY GEORGE CHERIAN, Jersey City, NJ (US); Priti P. Patil, Wakad (IN)

(21) Appl. No.: 18/999,753

(22) Filed: Dec. 23, 2024

(51) Int. Cl. G06V 30/19; G06Q 50/26; G06V 20/62; G06V 30/148; G07C 5/10

(52) U.S. Cl. CPC G06V 30/1908; G06Q 50/265; G06V 20/625; G06V 30/148; G07C 5/10; G06V 2201/08

(57) ABSTRACT

Determination of vehicle cloning using geo-location disparity includes determining a match between a first number plate of at least one first vehicle and a second number plate of at least one second vehicle. A geo-location disparity factor between the at least one first vehicle and the at least one second vehicle is determined. A confidence score is generated for the geo-location disparity factor and the confidence score is compared with a threshold disparity score. It is determined that the confidence score indicates vehicle cloning based on comparing the confidence score with a threshold disparity score. Accordingly, at least one alert is output based on the confidence score.

### BACKGROUND

The disclosure relates to Automated License Plate Recognition (ALPR) systems and more particularly, to the determination of vehicle cloning.

ALPR systems are designed to automatically capture images of vehicles and their license plates. The ALPR systems employ Optical Character Recognition (OCR) to convert the captured images into alphanumeric characters and compare the resulting plate numbers of the license plates against multiple databases. Comparing against the multiple databases allows for the identification of the vehicles' rightful owner. Further, the widespread availability and ease of use of image-capturing devices have created new opportunities to combat vehicles, particularly in cases of cloned license plates. Cloned plates allow unauthorized vehicles to operate under false profiles, making it difficult for authorities to identify the rightful owners and enforce vehicle regulations effectively.

### SUMMARY

According to an embodiment of the disclosure, a computer-implemented method for vehicle cloning determination using geo-location disparity is described. The computer-implemented method includes determining, by a computer, a match between a first number plate of at least one first vehicle and a second number plate of at least one second vehicle. The computer-implemented method further includes determining, by the computer, a geo-location disparity factor between the at least one first vehicle and the at least one second vehicle based on the determined match, vehicle information of the at least one first vehicle and the at least one second vehicle, timestamp data of the at least one first vehicle and the at least one second vehicle at one or more positions, and location coordinates of the one or more positions. Further, the computer-implemented method includes determining, by the computer, a confidence score for the geo-location disparity factor, based on at least one of the vehicle information, the timestamp data, or the location coordinates. The computer-implemented method further includes comparing, by the computer, the confidence score with a threshold disparity score. The computer-implemented method further includes obtaining, by the computer, an outcome of the comparison of the confidence score with the threshold disparity score. Furthermore, the computer-implemented method includes determining, by the computer, that the confidence score indicates the vehicle cloning of the at least one first vehicle or the at least one second vehicle based on the outcome. Further, the computer-implemented method includes outputting, by the computer, at least one alert based on the determination that the confidence score is indicative of vehicle cloning of the at least one first vehicle or the at least one second vehicle.

According to one or more embodiments of the disclosure, a computer system for vehicle cloning determination using geo-location disparity is described. The computer system performs a method for vehicle cloning determination using geo-location disparity. The method includes determining a match between a first number plate of at least one first vehicle and a second number plate of at least one second vehicle. The method further includes determining a geo-location disparity factor between the at least one first vehicle and the at least one second vehicle based on the determined match, vehicle information of the at least one first vehicle and the at least one second vehicle, timestamp data of the at least one first vehicle and the at least one second vehicle at one or more positions, and location coordinates of the one or more positions. The method includes determining a confidence score for the geo-location disparity factor based on at least one of the vehicle information, the timestamp data, or the location coordinates. The method further includes comparing the confidence score with a threshold disparity score. The method further includes obtaining an outcome of the comparison of the confidence score with the threshold disparity score. Further, the method includes determining that the confidence score indicates vehicle cloning of the at least one first vehicle or the at least one second vehicle based on the outcome. The method also includes classifying the at least one first vehicle or the at least one second vehicle as a cloned vehicle using the vehicle information and vehicle record data based on the determination that the confidence score indicates the vehicle cloning. Furthermore, the method includes outputting one or more classification alerts indicating that the at least one first vehicle or the at least one second vehicle is classified as the cloned vehicle.

According to one or more embodiments of the disclosure, a computer program product for vehicle cloning determination using geo-location disparity is described. The computer program product includes one or more computer-readable storage medium and program instructions stored on the one or more computer-readable storage media to perform operations. The program instructions include determining a match between a first number plate of at least one first vehicle and a second number plate of at least one second vehicle. The program instructions further include a geo-location disparity factor between the at least one first vehicle and the at least one second vehicle based on the determined match, vehicle information of the at least one first vehicle and the at least one second vehicle, timestamp data of the at least one first vehicle and the at least one second vehicle at one or more positions, and location coordinates of the one or more positions. The program instructions also include determining a confidence score for the geo-location disparity factor based on at least one of the vehicle information, the timestamp data, or the location coordinates. The program instructions further include comparing the confidence score with a threshold disparity score. The program instructions further include obtaining an outcome of the comparison of the confidence score with the threshold disparity score. Furthermore, the program instructions include determining that the confidence score indicates vehicle cloning of the at least one first vehicle or the at least one second vehicle based on the outcome. The program instructions also include outputting at least one alert based on the determination that the confidence score is indicative of vehicle cloning of the at least one first vehicle or the at least one second vehicle.

Additional technical features and benefits are realized through the techniques of the disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The following description will provide details of preferred embodiments with reference to the following figures wherein:

FIG. 1 is a diagram that illustrates a computing environment for the determination of vehicle cloning using the geo-location disparity, in accordance with an embodiment of the disclosure;

FIG. 2 is a diagram that illustrates an environment for the determination of vehicle cloning using the geo-location disparity, in accordance with an embodiment of the disclosure;

FIG. 3 is a diagram that illustrates exemplary operations for the determination of vehicle cloning using the geo-location disparity, in accordance with an embodiment of the disclosure;

FIG. 4 is a diagram that illustrates an exemplary determination of vehicle cloning using the geo-location disparity, in accordance with an embodiment in the disclosure;

FIG. 5 is a diagram that illustrates an exemplary scenario for the determination of vehicle cloning using the geo-location disparity, in accordance with an embodiment in the disclosure;

FIG. 6A and FIG. 6B, are diagrams that collectively illustrate a flowchart that illustrates an exemplary first method for the determination of vehicle cloning using the geo-location disparity, in accordance with an embodiment of the disclosure; and

FIG. 7A and FIG. 7B, are diagrams that collectively illustrate a flowchart that illustrates an exemplary second method for the determination of vehicle cloning using the geo-location disparity, in accordance with an embodiment of the disclosure.

### DETAILED DESCRIPTION

The increasing prevalence of Automated License Plate Recognition (ALPR) systems has revolutionized vehicle identification and monitoring. The ALPR systems capture images of vehicles and their license plates, converting them into alphanumeric characters through optical character recognition and comparing the results with established databases. Comparing against databases allows for the identification of the vehicle's owner. However, the rapid growth of accessible image-capturing devices has also exposed vulnerabilities, particularly regarding cloned license plates. The cloned license plates can be used by unauthorized vehicles, often operating far from their legitimate owners, making it challenging for authorities to enforce vehicle regulations and ensure public safety.

To address these issues, there is a need for an automated system that enhances the determination of the cloned license plates and improves the accuracy of vehicle identification. By leveraging advanced methodologies, the automated system aims to mitigate the risks associated with vehicle cloning and bolster the effectiveness of law enforcement efforts.

The proposed automated system aims to implement a method that detects instances when two vehicles are present at different locations nearly simultaneously. The method involves analyzing real-time data from multiple sources, such as GPS coordinates and timestamps, to determine the proximity of the vehicles to each other. By calculating the distances between the vehicles' reported locations and evaluating the time intervals of vehicles' movements, the automated system generates a confidence score that reflects the likelihood of fraudulent activity, such as vehicle cloning. The confidence score serves as an indicator for law enforcement and regulatory authorities, enabling them to prioritize investigations and take appropriate action in cases where the risk of fraud is deemed significant. Through the proposed automated system, the efficacy of vehicle identification processes is enhanced, and the overall integrity of vehicular monitoring systems is increased. For example, if two vehicles with the same license plate are detected at different locations almost simultaneously, the system flags this anomaly for further investigation. This immediate response enables authorities to act swiftly against potential vehicle cloning.

According to an embodiment of the disclosure, a computer-implemented method for vehicle cloning determination using geo-location disparity (alternatively called ‘geo-location disparity’) is described. The computer-implemented method includes determining, by a computer, a match between a first number plate of at least one first vehicle and a second number plate of at least one second vehicle. The computer-implemented method further includes determining, by the computer, the geo-location disparity factor between the at least one first vehicle and the at least one second vehicle based on the determined match, vehicle information of the at least one first vehicle and the at least one second vehicle, timestamp data of the at least one first vehicle and the at least one second vehicle at one or more positions, and location coordinates of the one or more positions. Further, the computer-implemented method includes determining, by the computer, a confidence score for the geo-location disparity factor, based on the vehicle information, the timestamp data, the location coordinates, or any combination thereof. The computer-implemented method further includes comparing, by the computer, the confidence score with a threshold disparity score. The computer-implemented method further includes obtaining, by the computer, an outcome of the comparison of the confidence score with the threshold disparity score. Furthermore, the computer-implemented method includes determining, by the computer, that the confidence score indicates the vehicle cloning of the at least one first vehicle or the at least one second vehicle based on the outcome. The computer-implemented method includes outputting, by the computer, at least one alert based on the determination that the confidence score is indicative of vehicle cloning of the at least one first vehicle or the at least one second vehicle.

In the determination of the match between the first number plate and the second number plate, the computer-implemented method further includes receiving, by the computer, a set of images of the at least one first vehicle and the at least one second vehicle from one or more data capturing devices. The one or more data capturing devices are positioned at a set of locations. The computer-implemented method further includes detecting, by the computer, the first number plate and the second number plate in the set of images. The computer-implemented method further includes detecting, by the computer, a first image of the first number plate and a second image of the second number plate in the set of images. Further, the computer-implemented method includes segmenting, by the computer, the first image and the second image from the set of images. The computer-implemented method further includes executing, by the computer, an Optical Character Recognition (OCR) process on the first image to extract a first set of characters from the first number plate using a first set of parameters. The first set of characters is extracted based on the segmentation of the first image. Further, the first set of parameters includes a font of the first set of characters, a size of the first set of characters, an angle of the first set of characters, lighting conditions of the first set of characters in the first number plate, or any combination thereof. Furthermore, the computer-implemented method further includes executing, by the computer, the OCR process on the second image to extract a second set of characters from the second number plate using a second set of parameters. The second set of characters is extracted based on the segmentation of the second image. Further, the second set of parameters includes a font of the second set of characters, a size of the second set of characters, an angle of the second set of characters, lighting conditions of the second set of characters in the second number plate, or any combination thereof. The method includes comparing, by the computer, the first set of characters with the second set of characters using one of a Machine Learning (ML) model or fuzzy matching. The method further includes determining, by the computer, the match between the first number plate and the second number plate based on the comparison of the first set of characters with the second set of characters.

In the determination of the geo-location disparity factor between the at least one first vehicle and the at least one second vehicle, the computer-implemented method includes determining, by the computer, a difference between the location coordinates of the at least one first vehicle and the location coordinates of the at least one second vehicle while the at least one first vehicle and the at least one second vehicle are moving through the one or more positions. The computer-implemented method further includes determining, by the computer, the geo-location disparity factor between the at least one first vehicle and the at least one second vehicle based on the difference between the location coordinates of the at least one first vehicle and the at least one second vehicle, the timestamp data, and the vehicle information. The geo-location disparity factor corresponds to a composite metric that quantitatively assesses spatial and temporal discrepancies between the at least one first vehicle and the at least one second vehicle.

In the comparison of the confidence score with the threshold disparity score, the computer-implemented method includes generating, by the computer, the threshold disparity score based on the vehicle information, the timestamp data, the location coordinates of the one or more positions, and vehicle record data. The threshold disparity score corresponds to a value that indicates a maximum level of geographic discrepancy between the location coordinates of the at least one first vehicle and the at least one second vehicle over time. Further, the computer-implemented method includes comparing, by the computer, the confidence score with the generated threshold disparity score.

In some embodiments of the disclosure, the vehicle record data includes vehicle history reports of the at least one first vehicle and the at least one second vehicle, spatial maps of the at least one first vehicle and the at least one second vehicle, insurance records of the at least one first vehicle and the at least one second vehicle, registration records of the at least one first vehicle and the at least one second vehicle, permitted speed limits at the one or more positions, weather data of the one or more positions, traffic data of the one or more positions, Department of Motor Vehicles (DMV) records of the at least one first vehicle and the at least one second vehicle, service records of the at least one first vehicle and the at least one second vehicle, or any combination thereof. The one or more positions correspond to specific locations where one or more data capture devices capture a set of images of the at least one first vehicle and the at least one second vehicle.

In obtaining the outcome of the comparison of the confidence score with the threshold disparity score, the computer-implemented method includes determining, by the computer, that the confidence score for the geo-location disparity factor exceeds the threshold disparity score based on the outcome of the comparison.

In determining that the confidence score indicates vehicle cloning, the computer-implemented method includes determining, by the computer, that the confidence score indicates vehicle cloning of the at least one first vehicle or the at least one second vehicle based on the determination that the confidence score for the geo-location disparity factor exceeds the threshold disparity score.

In some embodiments of the disclosure, the computer-implemented method further includes comparing, by the computer, the vehicle information of the at least one first vehicle and the at least one second vehicle with the vehicle record data based on the determination that the confidence score indicates the vehicle cloning. Further, the computer-implemented method includes classifying, by the computer, the at least one first vehicle or the at least one second vehicle as a cloned vehicle based on a result of the comparison of the vehicle information of the at least one first vehicle and the at least one second vehicle with the vehicle record data. Furthermore, the computer-implemented method includes generating, by the computer, one or more classification alerts to notify law enforcement authorities that the at least one first vehicle or the at least one second vehicle is classified as the cloned vehicle.

In some embodiments of the disclosure, the vehicle information includes a license plate number of the at least one first vehicle and the at least one second vehicle, a brand of the at least one first vehicle and the at least one second vehicle, a model of the at least one first vehicle and the at least one second vehicle, an year of manufacture of the at least one first vehicle and the at least one second vehicle, a color of the at least one first vehicle and the at least one second vehicle, a Vehicle Identification Number (VIN) of the at least one first vehicle and the at least one second vehicle, an engine type of the at least one first vehicle and the at least one second vehicle, a fuel type of the at least one first vehicle and the at least one second vehicle, interior features of the at least one first vehicle and the at least one second vehicle, exterior features of the at least one first vehicle and the at least one second vehicle, registration details of the at least one first vehicle and the at least one second vehicle, an insurance status of the at least one first vehicle and the at least one second vehicle, or any combination thereof.

In some embodiments of the disclosure, the computer-implemented method further includes tracking, by the computer, data associated with one or more activities of the at least one first vehicle and the at least one second vehicle based on the vehicle information and the timestamp data. Further, the computer-implemented method includes outputting, by the computer, the data associated with the one or more activities to law enforcement authorities based on a result of tracking of the data.

According to one or more embodiments of the disclosure, a computer system for vehicle cloning determination using geo-location disparity is described. The computer system performs a method for vehicle cloning determination using geo-location disparity. The method includes determining a match between a first number plate of at least one first vehicle and a second number plate of at least one second vehicle. The method further includes determining a geo-location disparity factor between the at least one first vehicle and the at least one second vehicle based on the determined match, vehicle information of the at least one first vehicle and the at least one second vehicle, timestamp data of the at least one first vehicle and the at least one second vehicle at one or more positions, and location coordinates of the one or more positions. The method includes determining a confidence score for the geo-location disparity factor based on the vehicle information, the timestamp data, the location coordinates, or any combination thereof. The method further includes comparing the confidence score with a threshold disparity score. The method further includes obtaining an outcome of the comparison of the confidence score with the threshold disparity score. Further, the method includes determining that the confidence score indicates vehicle cloning of the at least one first vehicle or the at least one second vehicle based on the outcome. The method also includes classifying the at least one first vehicle or the at least one second vehicle as a cloned vehicle using the vehicle information and vehicle record data based on the determination that the confidence score indicates the vehicle cloning. Furthermore, the method includes outputting one or more classification alerts indicating that the at least one first vehicle or the at least one second vehicle is classified as the cloned vehicle.

In some embodiments of the disclosure, the vehicle record data includes vehicle history reports of the at least one first vehicle and the at least one second vehicle, spatial maps of the at least one first vehicle and the at least one second vehicle, insurance records of the at least one first vehicle and the at least one second vehicle, registration records of the at least one first vehicle and the at least one second vehicle, permitted speed limits at the one or more positions, weather data of the one or more positions, traffic data of the one or more positions, Department of Motor Vehicles (DMV) records of the at least one first vehicle and the at least one second vehicle, service records of the at least one first vehicle and the at least one second vehicle, or any combination thereof. The one or more positions correspond to specific locations where one or more data capture devices capture a set of images of the at least one first vehicle and the at least one second vehicle.

In determining the match between the first number plate and the second number plate, the system is configured to receive a set of images of the at least one first vehicle and the at least one second vehicle from one or more data capturing devices. The one or more data capturing devices are positioned at a set of locations. The system is further configured to detect the first number plate and the second number plate in the set of images. Further, the system is configured to detect a first image of the first number plate and a second image of the second number plate in the set of images. Furthermore, the system is configured to segment the first image and the second image from the set of images. The system is further configured to execute an Optical Character Recognition (OCR) process on the first image to extract a first set of characters from the first number plate using a first set of parameters. The first set of characters is extracted based on the segmentation of the first image. The first set of parameters includes a font of the first set of characters, a size of the first set of characters, an angle of the first set of characters, lighting conditions of the first set of characters in the first number plate, or any combination thereof. Furthermore, the system is configured to execute the OCR process on the second image to extract a second set of characters from the second number plate using a second set of parameters. The second set of characters is extracted based on the segmentation of the second image. The second set of parameters includes a font of the second set of characters, a size of the second set of characters, an angle of the second set of characters, lighting conditions of the second set of characters in the second number plate, or any combination thereof. Further, the system is configured to compare the first set of characters with the second set of characters using one of an ML model or fuzzy matching. The system is further configured to determine the match between the first number plate and the second number plate based on the comparison of the first set of characters with the second set of characters.

In some embodiments of the disclosure, the vehicle information includes a license plate number of the at least one first vehicle and the at least one second vehicle, a brand of the at least one first vehicle and the at least one second vehicle, a model of the at least one first vehicle and the at least one second vehicle, an year of manufacture of the at least one first vehicle and the at least one second vehicle, a color of the at least one first vehicle and the at least one second vehicle, a Vehicle Identification Number (VIN) of the at least one first vehicle and the at least one second vehicle, an engine type of the at least one first vehicle and the at least one second vehicle, a fuel type of the at least one first vehicle and the at least one second vehicle, interior features of the at least one first vehicle and the at least one second vehicle, exterior features of the at least one first vehicle and the at least one second vehicle, registration details of the at least one first vehicle and the at least one second vehicle, an insurance status of the at least one first vehicle and the at least one second vehicle, or any combination thereof.

In some embodiments of the disclosure, the system is further configured to track data associated with one or more activities of the at least one first vehicle and the at least one second vehicle based on the vehicle information and the timestamp data. Further, the system is configured to output the data associated with the one or more activities to law enforcement authorities based on a result of tracking of the data.

According to one or more embodiments of the disclosure, a computer program product for vehicle cloning determination using geo-location disparity is described. The computer program product includes one or more computer-readable storage medium and program instructions stored on the one or more computer-readable storage media to perform operations. The program instructions include determining a match between a first number plate of at least one first vehicle and a second number plate of at least one second vehicle. The program instructions further include determining a geo-location disparity factor between the at least one first vehicle and the at least one second vehicle based on the determined match, vehicle information of the at least one first vehicle and the at least one second vehicle, timestamp data of the at least one first vehicle and the at least one second vehicle at one or more positions, and location coordinates of the one or more positions. The program instructions also include determining a confidence score for the geo-location disparity factor based on the vehicle information, the timestamp data, the location coordinates, or any combination thereof. The program instructions further include comparing the confidence score with a threshold disparity score. The program instructions further include obtaining an outcome of the comparison of the confidence score with the threshold disparity score. Furthermore, the program instructions include determining that the confidence score indicates vehicle cloning of the at least one first vehicle or the at least one second vehicle based on the outcome. The program instructions also include outputting at least one alert based on the determination that the confidence score is indicative of vehicle cloning of the at least one first vehicle or the at least one second vehicle.

In some embodiments of the disclosure, the program instructions stored on the one or more computer-readable storage media perform operations including comparing the vehicle information of the at least one first vehicle and the at least one second vehicle with vehicle record data based on the determination that the confidence score indicates the vehicle cloning. Further, the program instructions stored on the one or more computer-readable storage media perform operations including classifying the at least one first vehicle or the at least one second vehicle as a cloned vehicle based on a result of comparison of the vehicle information of the at least one first vehicle and the at least one second vehicle with the vehicle record data. The program instructions stored on the one or more computer-readable storage media perform operations including generating one or more classification alerts to notify law enforcement authorities that the at least one first vehicle or the at least one second vehicle is classified as the cloned vehicle.

In some embodiments of the disclosure, the vehicle record data includes vehicle history reports of the at least one first vehicle and the at least one second vehicle, spatial maps of the at least one first vehicle and the at least one second vehicle, insurance records of the at least one first vehicle and the at least one second vehicle, registration records of the at least one first vehicle and the at least one second vehicle, permitted speed limits at the one or more positions, weather data of the one or more positions, traffic data of the one or more positions, Department of Motor Vehicles (DMV) records of the at least one first vehicle and the at least one second vehicle, service records of the at least one first vehicle and the at least one second vehicle, or any combination thereof. The one or more positions correspond to specific locations where one or more data capture devices capture a set of images of the at least one first vehicle and the at least one second vehicle.

In some embodiments of the disclosure, the vehicle information includes a license plate number of the at least one first vehicle and the at least one second vehicle, a brand of the at least one first vehicle and the at least one second vehicle, a model of the at least one first vehicle and the at least one second vehicle, an year of manufacture of the at least one first vehicle and the at least one second vehicle, a color of the at least one first vehicle and the at least one second vehicle, a Vehicle Identification Number (VIN) of the at least one first vehicle and the at least one second vehicle, an engine type of the at least one first vehicle and the at least one second vehicle, a fuel type of the at least one first vehicle and the at least one second vehicle, interior features of the at least one first vehicle and the at least one second vehicle, exterior features of the at least one first vehicle and the at least one second vehicle, registration details of the at least one first vehicle and the at least one second vehicle, an insurance status of the at least one first vehicle and the at least one second vehicle, or any combination thereof.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated operation, concurrently, or in a manner at least partially overlapping in time.

In some embodiments of the disclosure, the program instructions stored on the one or more computer-readable storage media perform operations including track data associated with one or more activities of the at least one first vehicle and the at least one second vehicle based on the vehicle information and the timestamp data. Further, the operations include output the data associated with the one or more activities to law enforcement authorities based on the result of tracking of the data.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium is an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

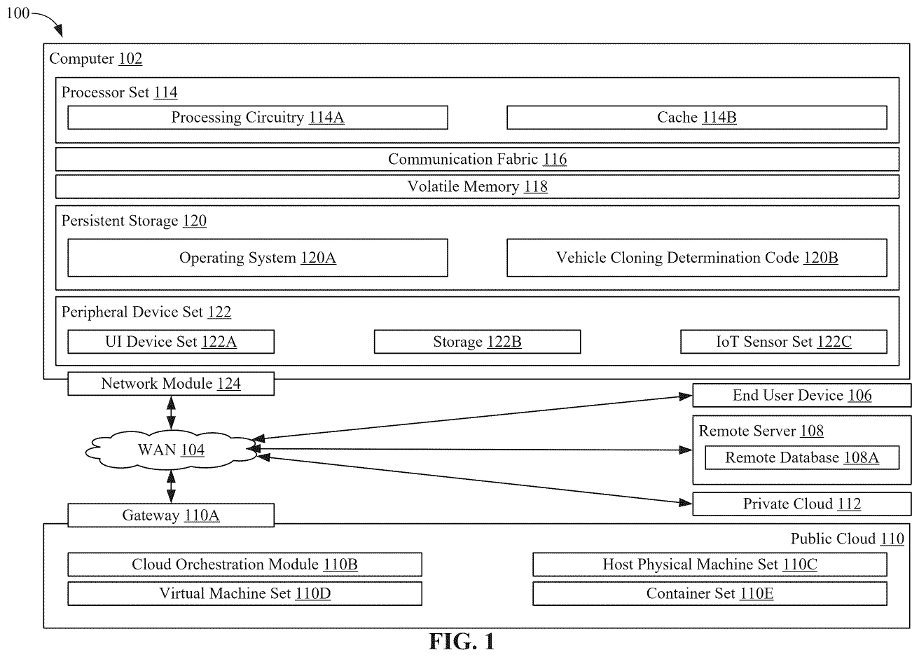

FIG. 1 is a diagram that illustrates a computing environment for the determination of vehicle cloning using the geo-location disparity, in accordance with an embodiment of the disclosure. With reference to FIG. 1, there is shown a computing environment 100 that contains an example of an environment for the execution of at least some of the computer code involved in performing the disclosed methods, such as vehicle cloning determination code 120B. In addition to the vehicle cloning determination code 120B for vehicle cloning determination, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the vehicle cloning determination code 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch, a robot, or other wearable computer, a mainframe computer, a quantum computer, or any other form of a computer or a mobile device now known or to be developed in the future that is capable of running a program, accessing a network or querying a database, such as a remote database 108A. As is well understood in the art of computer technology, and depending upon the technology, the performance of a computer-implemented method is distributed among multiple computers and/or between multiple locations. On the other hand, in this presentation of the computing environment 100, detailed discussion is focused on a single computer, specifically the computer 102, to keep the presentation as simple as possible. The computer 102 is located in a cloud, even though it is not shown in a cloud in FIG. 1. On the other hand, computer 102 is not required to be in a cloud except to any extent as is affirmatively indicated.

The processor set 114 includes one, or more, computer processors of any type now known or to be developed in the future. The processing circuitry 114A is distributed over multiple packages, for example, multiple, coordinated integrated circuit chips. The processing circuitry 114A may implement multiple processor threads and/or multiple processor cores. The cache 114B is a memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 is located “off-chip.” In some computing environments, the processor set 114 is designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in several types of computer-readable storage media, such as the cache 114B and the other storage media discussed below. The program instructions, and associated data, are accessed by the processor set 114 to control and direct the performance of the disclosed methods. In computing environment 100, at least some of the instructions for performing the disclosed methods are stored in the dynamic modification of the vehicle cloning determination code 120B in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Other types of signal communication paths are used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by a random access, but this is not required unless affirmatively indicated. In the computer 102, the volatile memory 118 is located in a single package and is internal to computer 102, but alternatively or additionally, the volatile memory 118 is distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 is a read-only memory (ROM), but typically at least a portion of the persistent storage 120 allows writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the vehicle cloning determination code 120B typically includes at least some of the computer code involved in performing the disclosed methods.

The peripheral device set 122 includes the set of peripheral devices of computer 102. Data communication connections between the peripheral devices and the other components of computer 102 are implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B is persistent and/or volatile. In some embodiments of the disclosure, storage 122B may take the form of a quantum computing storage device for storing data in the form of qubits. In embodiments of the disclosure where computer 102 is required to have a large amount of storage (for example, where computer 102 locally stores and manages a large database) then this storage is provided by peripheral storage devices designed for storing very large amounts of data, such as a storage area network (SAN) that is shared by multiple, geographically distributed computers. The IoT sensor set 122C is made up of sensors that can be used in Internet of Things applications. For example, one sensor is a thermometer, and another sensor is a motion detector.

The network module 124 is the collection of computer software, hardware, and firmware that allows computer 102 to communicate with other computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In some embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments of the disclosure, the WAN 104 is replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present recommendations to an end user. In some embodiments of the disclosure, EUD 106 is a client device, such as a thin client, heavy client, mainframe computer, desktop computer, and so on.

The remote server 108 is any computer system that serves at least some data and/or functionality to the computer 102. The remote server 108 is controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data is provided to the computer 102 from the remote database 108A of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs are stored as images and is transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in some embodiments of the disclosure, a private cloud is disconnected from the internet entirely and only accessible through a local/private network. A hybrid cloud is a composition of multiple clouds of diverse types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

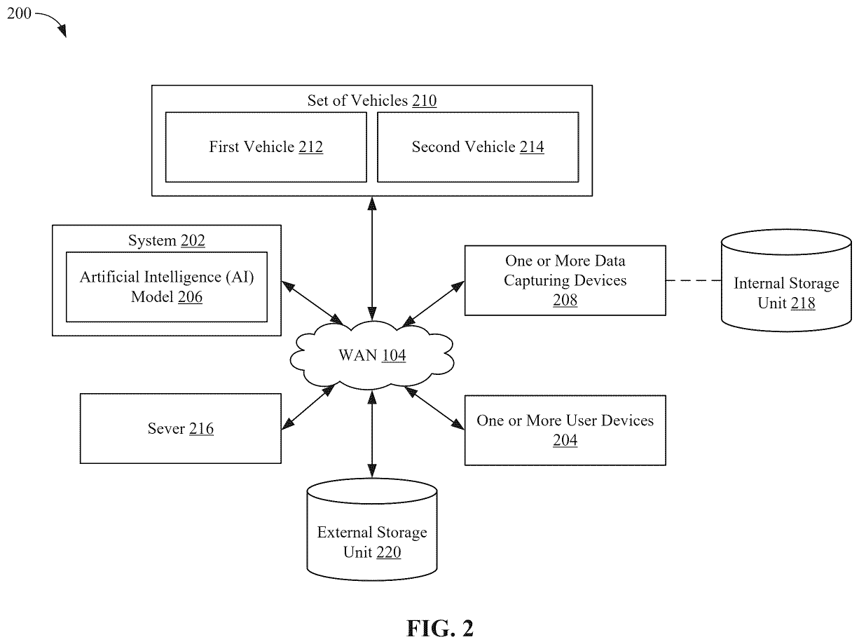

FIG. 2 is a diagram that illustrates an environment for the determination of vehicle cloning using the geo-location disparity, in accordance with an embodiment of the disclosure. FIG. 2 is explained in conjunction with elements from FIG. 1. With reference to FIG. 2, there is shown a diagram of a network environment 200. The network environment 200 includes a system 202, one or more user devices 204, an Artificial Intelligence (AI) Model 206, and one or more data capturing devices 208. There is further shown a set of vehicles 210 including a first vehicle 212 and a second vehicle 214, and a server 216. For the sake of brevity, the first vehicle 212, and the second vehicle 214 are shown in FIG. 2. However, there may be multiple first vehicles and multiple second vehicles. Further, the network environment 200 also includes a storage unit, such as an internal storage unit 218 and an external storage unit 220. The network environment 200 further includes a WAN 104 of FIG. 1. In an embodiment of the disclosure, the system 202 is an exemplary embodiment of the computer 102 in FIG. 1.

In an embodiment of the disclosure, each of the first vehicle 212 and the second vehicle 214 is connected independently to the system 202 using the WAN 104, such as 5G, 6G, and future wireless networks. This individual connectivity facilitates the transmission of real-time data from each of the first vehicle 212 and the second vehicle 214 to the system 202, allowing the system 202 to continuously monitor and analyze information related to each vehicle's geo-location, status, and behaviour. By harnessing high-speed and low-latency communication, the system 202 can receive timely updates from the first vehicle 212, and the second vehicle 214, ensuring that any potential anomalies indicative of vehicle cloning are swiftly detected. Further, each of the first vehicle 212, and the second vehicle 214 independently transmits data, such as timestamp information, location coordinates, and vehicle characteristics to the system 202. This capability enhances the accuracy of the geo-location disparity analysis, as the system 202 may assess each vehicle's movements and operational patterns in relation to historical data and external factors. The continuous flow of real-time data facilitates a proactive approach to identifying discrepancies, enabling law enforcement and vehicle owners to act quickly and effectively.

The system 202 may include suitable logic, circuitry, interfaces, and/or code that is configured for the determination of vehicle cloning using the geo-location disparity. In an embodiment, vehicle cloning is a form of vehicle fraud where the identity of one vehicle is copied and used to disguise another vehicle, often for unlawful purposes. The vehicle cloning involves duplication of the registration number plates of a legitimate vehicle (for example, the first vehicle 212) and attaching the duplicated number plates to a stolen or unregistered vehicle (for example, the second vehicle 214).

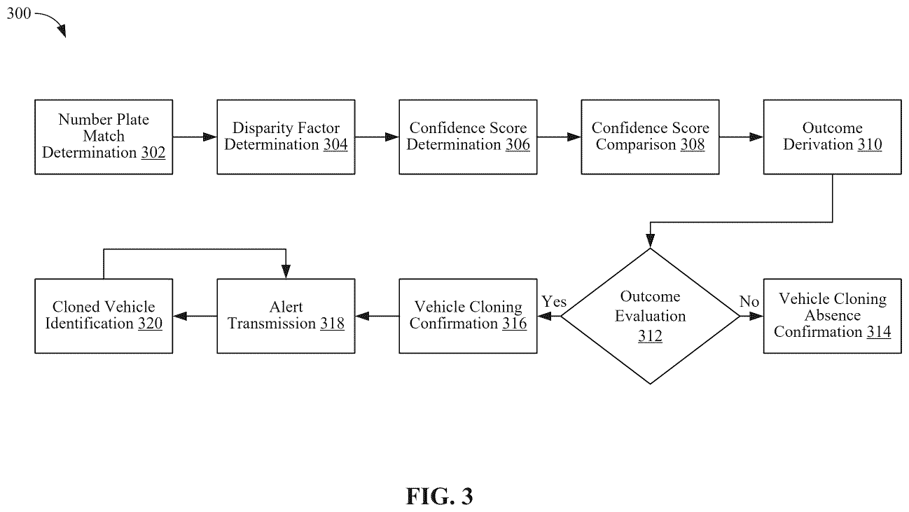

The system 202 is configured to determine a match between a first number plate of the first vehicle 212 and a second number plate of the second vehicle 214. The system 202 is configured to determine the geo-location disparity factor between the first vehicle 212 and the second vehicle 214 based on vehicle information of the first vehicle 212 and the second vehicle 214, timestamp data of the first vehicle 212 and the second vehicle 214 at one or more positions, and location coordinates of the one or more positions. In an embodiment of the disclosure, the vehicle information, the timestamp data, and the location coordinates of the one or more positions are stored in the storage unit. In an embodiment of the disclosure, the geo-location disparity factor corresponds to a composite metric that quantitatively assesses spatial and temporal discrepancies between the first vehicle 212 and the second vehicle 214. Details on determining the geo-location disparity factor between the first vehicle 212 and the second vehicle 214 have been explained with reference to, for example, FIG. 3.

The system 202 is further configured to determine a confidence score for the geo-location disparity factor, based on the vehicle information, the timestamp data, the location coordinates, or any combination thereof. Further, the system 202 is configured to compare the confidence score with a threshold disparity score. The system 202 is further configured to obtain an outcome of the comparison of the confidence score with the threshold disparity score. Furthermore, the system 202 is configured to determine that the confidence score indicates vehicle cloning of the first vehicle 212 or the second vehicle 214 based on the outcome. The system 202 is configured to output at least one alert based on the determination that the confidence score is indicative of vehicle cloning of the first vehicle 212 or the second vehicle 214. Examples of the system 202 may include, but are not limited to, a server, a computing device, a virtual computing device, a robot, a mainframe machine, a computer workstation, a smartphone, a cellular phone, a mobile phone, a gaming device, or a consumer electronic (CE) device. Details on determining the confidence score have been explained with reference to, for example, FIG. 3.

Further, the one or more user devices 204 include suitable logic, circuitry, interfaces, and/or code configured to receive the at least one alert indicative of vehicle cloning of the first vehicle 212 or the second vehicle 214. In an embodiment of the disclosure, the one or more user devices 204 include a display screen for receiving the at least one alert from the system 202. The one or more user devices 204 may also be configured to receive one or more classification alerts indicating that the first vehicle 212 or the second vehicle 214 is classified as the cloned vehicle. For example, the one or more user devices 204 may be used by users, such as law enforcement authorities, Vehicle Security Operations Centers (vSOCs), and the like, to receive alerts associated with the vehicle cloning. The one or more user devices 204 are communicatively coupled with the system 202 via the WAN. In an embodiment of the disclosure, each of the one or more user devices 204 is an exemplary embodiment of the EUD 106. Examples of the one or more user devices 204 may include, but are not limited to, a computing device, a mainframe machine, a server, a computer work-station, a robotic system, a smartphone, a cellular phone, a mobile phone, a gaming device, a consumer electronic (CE) device, a head-mounted device, a Virtual Reality (VR) Headset, an Augmented Reality (AR) Device, a Mixed Reality (MR) Device, a Projection-based System, and/or any other device with computer vision display capabilities. In an embodiment of the disclosure, the system 202 is implemented in the server 216. In an embodiment of the disclosure, the system 202 is implemented in each of the one or more data capturing devices 208. In an embodiment of the disclosure, the system 202 is implemented in the one or more user devices 204.

The one or more data capturing devices 208 correspond to devices configured to collect and record various types of data related to the set of vehicles 210, including a set of images of the set of vehicles 210, timestamp data of the set of vehicles 210 at one or more positions, and location coordinates of the one or more positions. The one or more data capturing devices 208 are typically deployed in strategic locations, such as stationary traffic poles, traffic light structures, mobile devices (e.g., patrolling cars or motorcycles), and the like. The positioning the one or more data capturing devices 208 allows the system 202 to monitor and analyze vehicular movement and behavior. In an embodiment, the one or more data capturing devices 208 are communicatively coupled with the system 202 via the WAN 104. As a result, the one or more data capturing devices 208 are enabled to transmit the captured data to the system 202 for detecting the vehicle cloning. In an embodiment of the disclosure, the one or more data capturing devices 208 may include Automatic License Plate Recognition (ALPR) Cameras, Global Positioning System (GPS) tracking devices, and the like. For example, ALPR cameras may correspond to high-resolution cameras that capture images of vehicles and the attached license plates. The data collected by the one or more data capturing devices 208 can be used for various applications, including traffic management, law enforcement, and accident analysis, allowing the system 202 to determine the geo-location disparity factor between the set of vehicles 210 and detect the vehicle cloning.

The display screen of the one or more user devices 204 may include suitable logic, circuitry, and interfaces configured to receive the at least one alert. In an embodiment of the disclosure, the display screen is an external display device associated with the one or more user devices 204. The display screen is a touch screen, such as a resistive touch screen, a capacitive touch screen, a thermal touch screen, or any combination thereof. In an embodiment of the disclosure, the display screen may refer to a display screen of a head-mounted device (HMD), a smart-glass device, a see-through display, a projection-based display, an electro-chromic display, or a transparent display. In an embodiment of the disclosure, the display screen is realized through several known technologies such as, but are not limited to, a Liquid Crystal Display (LCD) display, a Light Emitting Diode (LED) display, a plasma display, or an Organic LED (OLED) display technology, or other display devices.

The AI model 206 of the system 202 is a computational network or a system of artificial neurons, arranged in a plurality of layers, as nodes. The plurality of layers of the AI model 206 includes an input layer, one or more hidden layers, and an output layer. Each layer of the plurality of layers includes one or more nodes (or artificial neurons). Outputs of all nodes in the input layer are coupled to at least one node of hidden layer(s). Similarly, inputs of each hidden layer are coupled to outputs of at least one node in other layers of the AI model 206. Outputs of each hidden layer are coupled to inputs of at least one node in other layers of the AI model 206. Node(s) in the final layer receive inputs from at least one hidden layer to output a result. The number of layers and the number of nodes in each layer are determined from hyper-parameters of the AI model 206. Such hyper-parameters are set before or while training the AI model 206 on a training dataset.

Each node of the AI model 206 may correspond to a mathematical function (e.g., a sigmoid function or a rectified linear unit) with a set of parameters, tunable during training of the network. The set of parameters includes, for example, a weight parameter, a regularization parameter, and the like. Each node uses the mathematical function to compute an output based on one or more inputs from nodes in other layer(s) (e.g., previous layer(s)) of the AI model 206. All or some of the nodes of the AI model 206 may correspond to the same or a different mathematical function.

In training the AI model 206, one or more parameters of each node of the AI model 206 are updated based on whether an output of the final layer for a given input (from the training dataset) matches a correct result based on a loss function for the AI model 206. The above process is repeated for the same or a different input until a minima of loss function is achieved, and a training error is minimized. Several methods for training are known in art, for example, gradient descent, stochastic gradient descent, batch gradient descent, gradient boost, meta-heuristics, and the like.

The AI model 206 includes electronic data, such as, for example, a software program, code of the software program, libraries, applications, scripts, or other logic or instructions for execution by a processing device, such as processor set. The AI model 206 includes code and routines configured to enable a computing device, such as the system 202, to perform one or more operations. Additionally, the AI model 206 is implemented using hardware including a processor, a microprocessor (e.g., to perform or control performance of the one or more operations), a field-programmable gate array (FPGA), or an application-specific integrated circuit (ASIC). Alternatively, in some embodiments, the AI model 206 is implemented using a combination of hardware and software. Although in FIG. 2, the AI model 206 is shown to be integrated within the system 202, the disclosure is not so limited and the AI model 206 can be a separate entity from the system 202. In an embodiment, the AI model 206 is stored in the server 216. Examples of the AI model 206 may include, but are not limited to, a deep neural network (DNN), a convolutional neural network (CNN), a CNN-recurrent neural network (CNN-RNN), an artificial neural network (ANN), a fully connected neural network, and/or a combination of such networks.

In an embodiment, each of the internal storage unit 218 and the external storage unit 220 corresponds to an organized collection of data stored that can be accessed electronically from a computer system (such as the system 202). In an embodiment, the internal storage unit 218 is communicatively coupled to the one or more data capturing devices 208. The internal storage unit 218 is configured to store the data captured by the one or more data capturing devices 208. Further, the external storage unit 220 is communicatively coupled to the system 202 via the WAN 104. In an embodiment of the disclosure, the external storage unit 220 stores the vehicle information associated with the set of vehicles 210. For example, the vehicle information includes a license plate number of the first vehicle 212 and the second vehicle 214, a brand of the first vehicle 212 and the second vehicle 214, a model of the first vehicle 212 and the second vehicle 214, an year of manufacture of the first vehicle 212 and the second vehicle 214, a color of the first vehicle 212 and the second vehicle 214, a Vehicle Identification Number (VIN) of the first vehicle 212 and the second vehicle 214, an engine type of the first vehicle 212 and the second vehicle 214, a fuel type of the first vehicle 212 and the second vehicle 214, interior features of the first vehicle 212 and the second vehicle 214, exterior features of the first vehicle 212 and the second vehicle 214, registration details of the first vehicle 212 and the second vehicle 214, an insurance status of the first vehicle 212 and the second vehicle 214, or any combination thereof. Further, each of the internal storage unit 218 and the external storage unit 220 are designed to manage, store, retrieve, and update data efficiently. The structure of each of the internal storage unit 218 and the external storage unit 220 typically involves tables, records, and fields that can be managed through various database management systems (DBMS). Examples of each of the internal storage unit 218 and the external storage unit 220 unit may include, but are not limited to, a relational database, a Non-Structured Query Language (SQL) database, a hierarchical database, a network database, a transactional database, a data warehouse, a distributed database, and a data lake.

In an embodiment of the disclosure, the server 216 is configured to store the AI model 206 on the internal storage unit 218 or the external storage unit 220.

In an embodiment of the disclosure, the server 216 is implemented as a cloud server and may execute operations through web applications, cloud applications, HTTP requests, repository operations, file transfer, and the like. Other example implementations of the server 216 include, but are not limited to, a database server, a file server, a web server, a media server, an application server, a mainframe server, or a cloud computing server.

In an embodiment of the disclosure, the server 216 is implemented as a plurality of distributed cloud-based resources by use of several technologies that are well known to those ordinarily skilled in the art. A person with ordinary skill in the art will understand that the scope of the disclosure may not be limited to the implementation of the server 216 and the system 202 as two separate entities. In certain embodiments, the functionalities of the server 216 can be incorporated in its entirety or at least partially in the system 202, without a departure from the scope of the disclosure.

In operation, the system 202 is configured to match the number plate of the first vehicle 212 with the number plate of the second vehicle 214. Further, the system 202 is configured to determine the geo-location disparity factor based on the vehicle information, timestamps, and location coordinates of the set of vehicles 210. The system 202 is further configured to assess the confidence score for the disparity factor and compares the confidence score against the threshold disparity score. If the confidence score exceeds the threshold disparity score, the system 202 determines a potential vehicle cloning incident and generates the at least one alert indicative of vehicle cloning.

FIG. 3 is a diagram that illustrates exemplary operations for the determination of vehicle cloning using the geo-location disparity, in accordance with an embodiment of the disclosure. FIG. 3 is explained in conjunction with elements from FIG. 1, and FIG. 2. With reference to FIG. 3, there is shown a block diagram 300 that illustrates exemplary operations from 302 to 320, as described herein. The exemplary operations illustrated in the block diagram 300 start at 302 and are performed by any computing system, apparatus, or device, such as by the computer 102 of FIG. 1 or system 202 of FIG. 2. Although illustrated with discrete blocks, the exemplary operations associated with one or more blocks of the block diagram 300 are divided into additional blocks, combined into fewer blocks, or eliminated, depending on the particular implementation.

At 302, a number plate match determination operation is executed. In the number plate match determination operation, the system 202 is configured to determine the match between a first number plate of the at least one first vehicle and a second number plate of the at least one second vehicle. In the determination of the match between the first number plate and the second number plate, the system 202 is configured to receive the set of images of the at least one first vehicle and the at least one second vehicle from the one or more data capturing devices 208. In an embodiment of the disclosure, the one or more data capturing devices 208 are positioned at a set of locations. For example, the set of locations may be stationary traffic poles, traffic light structures, mobile devices (e.g., patrolling cars or motorcycles), and the like. Further, the system 202 is configured to detect the first number plate and the second number plate in the set of images. For example, the system 202 identifies that the first number plate is located at the center of one of the set of images. The system 202 identifies that the first number plate is located at the center of one of the set of images by applying image processing techniques, including preprocessing to enhance image quality, detecting regions of interest, isolating the number plate using contour detection, and then applying Optical Character Recognition (OCR) to extract the characters from that central area.

Further, the system 202 is configured to detect a first image of the first number plate and a second image of the second number plate in the set of images. The system 202 is further configured to segment the first image and the second image from the set of images. In an exemplary embodiment of the disclosure, Region-based Convolutional Neural Network (R-CNN) or similar architecture may be used to locate and segment the first image and the second image. The system 202 then applies image enhancement techniques on the first image and the second image, such as contrast adjustment, sharpening, and noise reduction to improve the readability of the first number plate and the second number plate. Furthermore, the system 202 is configured to execute an OCR process on the first image to extract a first set of characters from the first number plate using a first set of parameters. In an embodiment of the disclosure, the first set of characters refers to the alphanumeric symbols extracted from the first number plate of the first vehicle using OCR techniques, which represent the unique identification code of the vehicle. In an embodiment of the disclosure, the system is configured to use the ML model on the first image to extract a first set of characters from the first number plate using a first set of parameters. In an embodiment of the disclosure, the first set of characters is extracted based on the segmentation of the first image. In an exemplary embodiment of the disclosure, the first set of parameters includes specific characteristics of the first set of characters used during the OCR process, such as a font of the first set of characters, a size of the first set of characters, an angle of the first set of characters, lighting conditions of the first set of characters in the first number plate, or any combination thereof.

Further, the system 202 is configured to execute the OCR process on the second image to extract a second set of characters from the second number plate using a second set of parameters. In an embodiment of the disclosure, the second set of characters is extracted based on the segmentation of the second image. In an exemplary embodiment of the disclosure, the second set of parameters includes a font of the second set of characters, a size of the second set of characters, an angle of the second set of characters, lighting conditions of the second set of characters in the second number plate, or any combination thereof. The system 202 is configured to compare the first set of characters with the second set of characters using one of the ML model or fuzzy matching. The system 202 is further configured to determine the match between the first number plate and the second number plate based on the comparison of the first set of characters with the second set of characters.

The extraction of the first set of characters and the second set of characters encompasses not only the identification of the number plate itself but also the systematic storage of associated contextual information, including the date, time, and geographic location of the image capture. This comprehensive data set serves multiple analytical purposes. By maintaining a chronological database of license plate captures, law enforcement agencies can effectively track the movements of specific vehicles over time. For example, if a vehicle with a suspicious license plate is recorded at various locations, the authorities can analyze the vehicle's travel patterns using the system 202 to ascertain potential connections to unlawful activities. Additionally, the stored data facilitates the identification of behavioral patterns, for example, if a particular vehicle consistently appears in specific areas at designated times, this may indicate habitual activities warranting further investigation. The chronological database can also be cross-referenced against established lists of license plates associated with illicit activities. In instances where a vehicle is identified with a plate that matches one from a known list of stolen vehicles, this can trigger immediate alerts for law enforcement intervention. The insights derived from this analytical framework empower organizations to make informed and data-driven decisions. For law enforcement, this means optimizing resource allocation by identifying geographic areas with elevated incidents of suspicious vehicle activity, thereby enhancing the effectiveness of patrol strategies. For enterprises managing vehicle fleets, monitoring routes and timings can yield optimized delivery schedules, reduced fuel expenditures, and improved operational efficiency.

In an embodiment of the disclosure, the license plate comparison may be performed through various methodologies, such as an exact match technique. In an embodiment of the present disclosure, the exact match technique involves comparing the first set of characters from the first number plate directly against the second set of characters from the second number plate to determine if they are identical. If all characters match in both content and order, a positive match is confirmed, indicating that the two number plates are the same. To enhance the accuracy and efficiency of license plate comparison, a fuzzy matching technique may be used. For example, the fuzzy matching technique is the Jaro-Winkler distance algorithm, which quantifies the similarity between two strings by calculating a distance metric that ranges from 0 to 1. In this context, a score of 1 signifies a perfect match, while a score of 0 indicates complete dissimilarity. By leveraging the Jaro-Winkler distance algorithm, the system 202 can identify potential matches that would otherwise be overlooked using exact matching techniques.

Along with directly comparing license plates, the system may use a set of attributes to enhance the accuracy of the vehicle cloning determination. By incorporating the set of attributes such as color, shape, or model of the vehicle, the system 202 can cross-reference and validate matches further, enhancing the reliability of the findings. For example, if a license plate match is found between two vehicles, cross-referencing their color and shape can help confirm whether they are likely to be the same vehicle, especially in cases where the plate might be obscured or partially visible. This multifaceted approach to vehicle identification not only increases accuracy but also bolsters the overall robustness of reporting capabilities of the system 202.

At 304, a disparity factor determination operation is executed. In the disparity factor determination operation, the system 202 is configured to determine the geo-location disparity factor between the at least one first vehicle and the at least one second vehicle based on the determined match, the vehicle information of the at least one first vehicle and the at least one second vehicle, the timestamp data of the at least one first vehicle and the at least one second vehicle at one or more positions, and the location coordinates of the one or more positions. In an embodiment of the disclosure, the timestamp data refers to the specific time recorded when data about the at least one first vehicle and the at least one second vehicle is captured. The timestamp data includes date and time information associated with the at least one first vehicle and the at least one second vehicle.

In an exemplary embodiment of the disclosure, the vehicle information includes a license plate number of the at least one first vehicle and the at least one second vehicle, a brand of the at least one first vehicle and the at least one second vehicle, a model of the at least one first vehicle and the at least one second vehicle, an year of manufacture of the at least one first vehicle and the at least one second vehicle, a color of the at least one first vehicle and the at least one second vehicle, a Vehicle Identification Number (VIN) of the at least one first vehicle and the at least one second vehicle, an engine type of the at least one first vehicle and the at least one second vehicle, a fuel type (e.g., diesel or petrol) of the at least one first vehicle and the at least one second vehicle, interior features of the at least one first vehicle and the at least one second vehicle, exterior features of the at least one first vehicle and the at least one second vehicle, registration details of the at least one first vehicle and the at least one second vehicle, an insurance status of the at least one first vehicle and the at least one second vehicle, or any combination thereof.

In the determination of the geo-location disparity factor between the at least one first vehicle and the at least one second vehicle, the system 202 is configured to determine a difference between the location coordinates of the at least one first vehicle and the location coordinates of the at least one second vehicle while the at least one first vehicle and the at least one second vehicle are moving through the one or more positions. Further, the system 202 is configured to determine the geo-location disparity factor between the at least one first vehicle and the at least one second vehicle based on the difference between the location coordinates of the at least one first vehicle and the at least one second vehicle, the timestamp data, and the vehicle information. In an embodiment of the disclosure, the geo-location disparity factor corresponds to a composite metric that quantitatively assesses spatial and temporal discrepancies between the at least one first vehicle and the at least one second vehicle.

For example, the location coordinates of vehicle A for a particular position of the one or more positions are latitude 34.0522° N and longitude 118.2437° W, the timestamp data of vehicle A is 2024 Sep. 26 10:00:00, and vehicle information of vehicle A is model X and color Blue. Further, the location coordinates of vehicle B for a particular position of the one or more positions are latitude 34.0525° N and longitude 118.2440° W, the timestamp data of vehicle B is 2024 Sep. 26 10:05:00, and vehicle information of vehicle B is model Y and color Red. The system 202 calculates the difference between the location coordinates of vehicle A and vehicle B. The calculated difference may indicate a distance between the vehicle A and the vehicle B to be 30 meters. The system 202 also considers the timestamps and determines the time difference between the two vehicles' readings. In this case, the time difference is 5 minutes. Further, the system 202 determines the geo-location disparity factor based on both the distance and the time difference. The geo-location disparity factor may be represented as a composite metric that assesses how far apart the vehicles are spatially and how much time has elapsed between their recorded locations. The system 202 generates a geo-location disparity factor, say a confidence score of 0.1, which indicates a low degree of spatial and temporal discrepancy between the two vehicles, suggesting that they are relatively close in both time and space.

At 306, a confidence score determination operation is executed. In the confidence score determination, the system 202 is configured to determine a confidence score for the geo-location disparity factor, based on the vehicle information, the timestamp data, the location coordinates, or any combination thereof. In an embodiment of the disclosure, the confidence score is generated by assessing and weighing various factors related to the vehicle information, the timestamp data, and the location coordinates. The resulting composite score quantitatively reflects the likelihood of a legitimate match between the two vehicles, aiding in the determination of potential vehicle cloning.

At 308, a confidence score comparison operation is executed. In the confidence score comparison operation, the system 202 is configured to compare the confidence score with the threshold disparity score. Before comparing the confidence score with the threshold disparity score, the system 202 is configured to generate the threshold disparity score based on the vehicle information, the timestamp data, the location coordinates of the one or more positions, and vehicle record data. In an embodiment of the disclosure, the threshold disparity score corresponds to a value that indicates a maximum level of geographic discrepancy between the location coordinates of the at least one first vehicle and the at least one second vehicle over time. In an embodiment of the disclosure, the threshold disparity score is generated through a thorough analysis of historical data and statistical methods to define acceptable levels of geographic and temporal discrepancies between the at least one first vehicle and the at least one second vehicle. Further, the system 202 is configured to compare the confidence score with the generated threshold disparity score. For example, the vehicle record data includes vehicle history reports of the at least one first vehicle and the at least one second vehicle, spatial maps of the at least one first vehicle and the at least one second vehicle, insurance records of the at least one first vehicle, and the at least one second vehicle, registration records of the at least one first vehicle and the at least one second vehicle, permitted speed limits at the one or more positions, weather data of the one or more positions, traffic data of the one or more positions, Department of Motor Vehicles (DMV) records of the at least one first vehicle and the at least one second vehicle, service records of the at least one first vehicle and the at least one second vehicle, or any combination thereof. In an embodiment of the disclosure, the one or more positions correspond to specific locations where one or more data capture devices capture the set of images of the at least one first vehicle and the at least one second vehicle.

At 310, an outcome derivation operation is executed. In the outcome derivation operation, the system 202 is configured to obtain an outcome by comparing the confidence score with the threshold disparity score. In an embodiment of the disclosure, the outcome corresponds to a result of the comparison, as explained using at least steps 312, 314, and 314.

At 312, an outcome evaluation operation is executed. In the outcome evaluation operation, the system 202 is configured to evaluate the outcome of step 310. If the confidence score for the geo-location disparity factor fails to exceed the threshold disparity score, the system 202 performs step 314. Further, if the confidence score for the geo-location disparity factor exceeds or is equal to the threshold disparity score, the system 202 performs step 316.

At 314, a vehicle cloning absence confirmation operation is executed. In the vehicle cloning absence confirmation operation, it is determined that both the at least one first vehicle and the at least one second vehicle are the same based on the result of step 312. In an embodiment of the disclosure, the system 202 determines that both the at least one first vehicle and the at least one second vehicle are the same based on the outcome of the comparison of the confidence score with the generated threshold disparity score.

At 316, a vehicle cloning confirmation operation is executed. In the vehicle cloning confirmation operation, the system 202 is configured to determine that the confidence score indicates vehicle cloning of the at least one first vehicle or the at least one second vehicle based on the outcome of step 312. In an embodiment of the disclosure, the system 202 determines that the confidence score for the geo-location disparity factor exceeds the threshold disparity score based on the outcome of the comparison at step 312. As a result, the system determines that the confidence score indicates vehicle cloning of the at least one first vehicle or the at least one second vehicle based on the determination that the confidence score for the geo-location disparity factor exceeds the threshold disparity score. For example, the system 202 determines that the at least one first vehicle or the at least one second vehicle is cloned by analyzing discrepancies in their number plates, significant differences in the vehicle information, and substantial geo-location disparities coupled with timestamps that suggest they cannot be in the same place at the same time.

At 318, an alert transmission operation is executed. In the alert transmission operation, the system 202 is configured to generate and output the at least one alert based on the confidence score. In an embodiment, the at least one alert indicates that no vehicle cloning is performed based on the result of step 314. In an embodiment, the confidence score is indicative of vehicle cloning of the at least one first vehicle or the at least one second vehicle based on the result of step 316. For example, the system 202 may generate visual alerts including pop-up messages on the display screen of the one or more user devices 204 saying “no vehicle cloning detected.” Further, the system 202 may also generate audio alerts, haptic alerts, light alerts (e.g., flashing red light on the display screen, and the like.

At 320, a cloned vehicle identification operation is executed. In the cloned vehicle identification operation, the system 202 is configured to compare the vehicle information of the at least one first vehicle and the at least one second vehicle with the vehicle record data based on the determination that the confidence score indicates the vehicle cloning. Further, the system 202 is configured to classify the at least one first vehicle or the at least one second vehicle as a cloned vehicle based on the result of comparison of the vehicle information of the at least one first vehicle and the at least one second vehicle with the vehicle record data. Further, at step 318, the system 202 is configured to generate one or more classification alerts to notify law enforcement authorities that the at least one first vehicle or the at least one second vehicle is classified as a cloned vehicle. For example, the system 202 detects two vehicles, vehicle A and vehicle B, both displaying the number plate XYZ789. Vehicle A is confirmed to be a model A and color Red, while vehicle B is identified as a model B and color Red. The system 202 compares the vehicle information of both the vehicles with the vehicle record data (e.g., a national vehicle registry) which shows that the number plate XYZ789 is registered to a Model A. Since Vehicle A matches the registry, but Vehicle B does not align with the model specified in the vehicle record data, the system 202 concludes that vehicle B is the cloned vehicle. Consequently, it generates an alert to notify law enforcement authorities of this classification, indicating potential vehicle cloning.

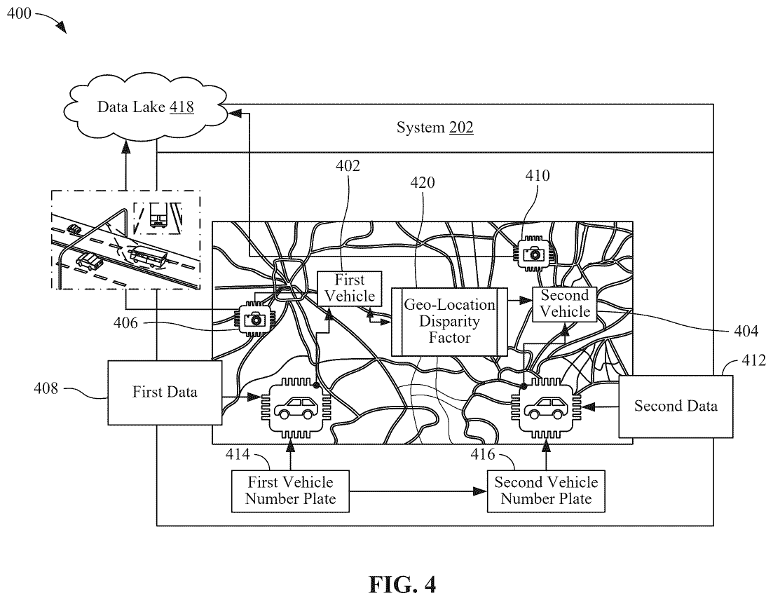

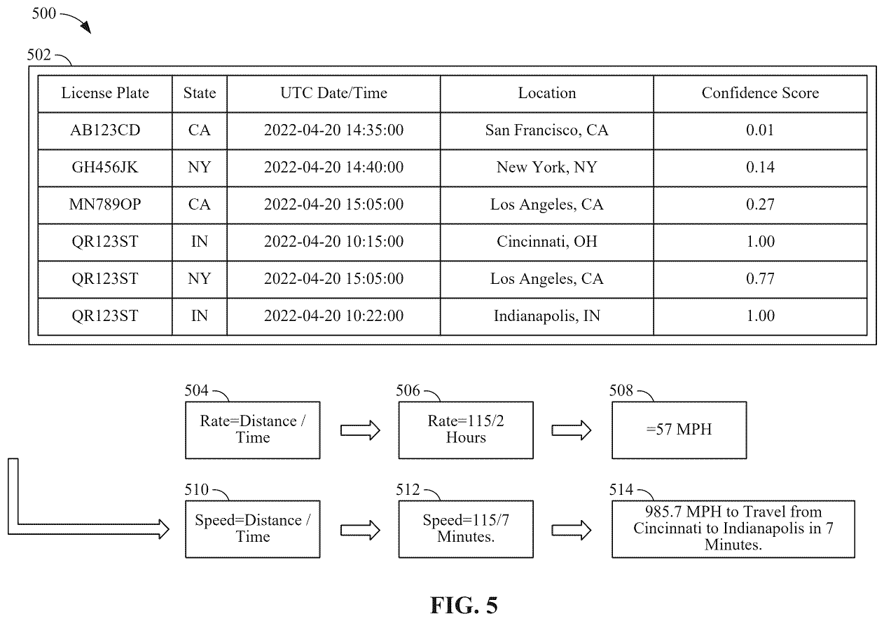

In an embodiment of the disclosure, the system 202 is configured to track data associated with one or more activities of the at least one first vehicle and the at least one second vehicle based on the vehicle information and the timestamp data. For example, the system 202 tracks speed to detect instances of speeding or erratic driving behavior. Additionally, the system 202 analyzes stop-and-go patterns to determine how long each vehicle stops at specific locations, such as gas stations or parking lots, which can indicate either unusual or legitimate activity. By capturing this data, the system 202 can provide law enforcement authorities with detailed insights, facilitating timely responses to potential vehicle cloning or other illicit activities. Additionally, the system 202 can generate geofencing alerts when either vehicle enters or exits predefined zones, logging these events for further investigation. The system 202 also captures timestamped events like fuel purchases, maintenance records, and toll payments to provide insights into usage patterns, as well as any communication logs made from within the vehicles, such as emergency calls. This comprehensive tracking enables the system 202 to output relevant data and alerts to law enforcement authorities, facilitating timely responses to potential vehicle cloning or other illicit activities. Details on the determination of vehicle cloning using the geo-location disparity have been explained using examples in FIG. 4 and FIG. 5.

FIG. 4 is a diagram that illustrates an exemplary determination of vehicle cloning using the geo-location disparity factor, in accordance with an embodiment in the disclosure. FIG. 4 is explained in conjunction with elements from FIG. 1, FIG. 2, and FIG. 3. With reference to FIG. 4, there is shown an exemplary diagram 400 including a first vehicle 402 and a second vehicle 404. Further, one or more first data capturing devices 406 located at a first position captures first data 408 associated with the first vehicle 402. In an exemplary embodiment, the first position has location coordinated as 39.681975, −86.253269. For example, the first data 408 associated with the first vehicle 402 includes model ABC, color black, and active: 10:15 AM Eastern Standard Time (EST).

Furthermore, one or more second data capturing devices 410 located at a second position captures second data 412 associated with the second vehicle 404. In an exemplary embodiment, the second position has location coordinated as 39.654156, −84.401840. For example, the second data 412 associated with the second vehicle 404 includes model ABC, color black, and active: 10:22 AM EST. In an embodiment of the disclosure, the system 202 determines that the first vehicle number plate 414 (also called “first license plate”) associated with the first vehicle 402 is “QR123RT”. Further, the system 202 determines that a second vehicle number plate 416 (also called “second license plate”) associated with the second vehicle 404 is “QR123RT”. In an embodiment of the disclosure, the system 202 determines that the first vehicle number plate 414, and the second vehicle number plate 416 are the same.

In an embodiment of the disclosure, the data captured by the one or more first data capturing devices 406 and the one or more second data capturing devices 410 is stored in a data lake 418. In an embodiment of the disclosure, the data lake 418 provides a centralized repository for storing vast amounts of structured and unstructured data (e.g., the data captured by the one or more first data capturing devices 406 and the one or more second data capturing devices 410), enabling flexible data analysis and insights for the determination of vehicle cloning. Further, the system 202 calculates the geo-location disparity factor based on the location coordinates of the first position and the second position. For example, the geo-location disparity factor 420 between the first vehicle 402, and the second vehicle 404 is defined as 115 miles and 2 hours. The geo-location disparity factor 420 quantifies the difference in both spatial and temporal dimensions between the first position and the second position. Specifically, 115 miles represents the physical distance separating the first vehicle 402, located at coordinates 39.681975, 86.253269, from the second vehicle 404, located at coordinates 39.654156, −84.401840. This measurement indicates how far apart the vehicles are in terms of geographic space. The additional component of 2 hours refers to the time difference, suggesting that the vehicles were recorded at these locations at times that are 2 hours apart, highlighting the temporal separation between their activities. Together, these metrics provide a composite assessment of how far apart and how differently timed the two vehicles are, which is relevant for evaluating potential vehicle cloning or other irregularities.

Further, the system 202 determines that the significant distance of 115 miles indicates that the two vehicles may not realistically be in the same vicinity at the same time. Additionally, the 2-hour time discrepancy further complicates the scenario, as it suggests that if both vehicles may be legitimate, they could not have traveled from the first position to the second position within such a short time frame. The system 202 compares the confidence score with the threshold disparity score and concludes that it is highly improbable for both vehicles to exist legitimately under these circumstances. Therefore, the geo-location disparity serves as an indicator that one of the vehicles is likely to be a cloned version. Accordingly, the system 202 generates alerts for law enforcement authorities to notify the law enforcement authority about a potential vehicle cloning incident.

FIG. 5 is a diagram that illustrates an exemplary scenario for the determination of vehicle cloning using the geo-location disparity, in accordance with an embodiment in the disclosure. FIG. 5 is explained in conjunction with elements from FIG. 1, FIG. 2, FIG. 3, and FIG. 4.

With reference to FIG. 5, an exemplary diagram 500 shows a set of operations for the determination of vehicle cloning using the geo-location disparity. The exemplary diagram 500 shows a table 502 having a set of fields, such as license plate, state, time, location, and confidence score associated with the set of vehicles 210.

Upon discovery of a ‘1’ or ‘perfect match between vehicle license plates of two vehicles, the system 202 suggests a potential case of duplication or cloning of the vehicle. As shown in the table 502, two vehicles have the same license plate i.e., “QR123ST”. This initial confirmation prompts the system 202 to undertake further analysis to assess the legitimacy of the match. Further, the system 202 compares the timestamps and proximity of the two vehicles to establish and validate any disparity. A key differentiation item in this process is the confidence score, which helps answer the question: Is it possible that this is the same vehicle observed at different times of day or in different locations? To analyze this, the system 202 applies equation (1) to evaluate the feasibility of the observed data.

In an embodiment of the disclosure, both the vehicles are last seen with only a 7-minute disparity between their timestamps. Further, the system 202 queries an Application Programming Interface (API) to determine the distance between the two locations—Cincinnati, OH, and Indianapolis, IN. The response to this query indicates a distance of 115 miles. This measurement highlights a significant geographic separation between the two vehicles.

Further, the system 202 determines the threshold disparity score to identify indicators of duplicate license plates across disparate locations. With a distance of 115 miles and a logged 7-minute time disparity, the system 202 may apply the formula for rate (equation 1) to assess the feasibility of both vehicles being in these locations simultaneously, at 504.

$$R = D / T \qquad ( 1 )$$

Where R is rate/speed, D is distance, and T is time.

Further, an expected average speed is calculated based on the distance of 115 miles and the expected time to cover 115 miles (e.g., 2 hours) using equation (2), at step 506.

$$R = 115 / 2 \qquad ( 2 )$$

At step 508, the system 202 determines that the expected average speed is 57 mph. Further, at steps 510 and 512, the system 202 again uses the equation (1) to calculate the rate/speed required to cover 115 miles in 7 minutes. The system 202 determines at step 514 that a vehicle may require a speed of approximately 985 mph to cover 115 miles in 7 minutes. This finding suggests that the scenario is highly unlikely. Based on these calculations, the system 202 evaluates whether the rate of travel exceeds a threshold (for example, 90 mph). If the calculated rate is less than or equal to 90 mph, the event is deemed potentially feasible. If the rate exceeds the threshold, the system 202 determines that the at least one first vehicle or the at least one second vehicle is cloned.

Once the threshold is exceeded, the system can further analyze the vehicle information against the Department of Motor Vehicles (DMV) database and examine details of the vehicle, such as brand, color, and type (e.g., truck, SUV). This analysis is significant for identifying which vehicle is cloned, especially in cases where the vehicle may be using multiple license plates. Any vehicle that does not match DMV records may be flagged within the system 202, and each crossing may be recorded, establishing a trail to monitor the cloned vehicle's location. This capability is used by law enforcement to ensure timely intervention when required.

In an embodiment of the disclosure, the system 202 is designed to provide a range of applications that enhance vehicle security and operational efficiency. One of the primary use cases is vehicle plate cloning determination and prevention. By promptly identifying cloned license plates, the system 202 mitigates fraudulent activities such as toll evasion, gas station drive-offs, and parking violations. This capability helps maintain the integrity of traffic management systems and minimizes revenue loss for businesses and agencies.

In the realm of insurance claims management, the system 202 delivers crucial evidence and accurate data regarding the location and timing of vehicles involved in accidents. This information assists insurers in verifying claims, reducing instances of fraud, and ensuring fair compensation for legitimate claims. By enhancing the reliability of the claims process, the system 202 contributes to a more trustworthy insurance environment. Further, the system 202 significantly bolsters vehicle security through real-time monitoring and alerts. The system 202 continuously tracks vehicle movements, flagging any instances of cloned license plates. When potential fraud is detected, real-time alerts are generated for the Vehicle Security Operations Center (SOC), enabling swift responses to suspicious activities. In addition to detecting cloned plates, the system 202 may identify stolen vehicles by flagging any sightings of vehicles with reported stolen plates, thereby facilitating immediate intervention by law enforcement.

The integration of geofencing capabilities further enhances security measures. Vehicle SOCs can establish virtual perimeters around designated areas, allowing for alerts if a vehicle with a cloned plate deviates from its planned route or enters restricted zones. Furthermore, incorporating driver verification systems ensures that only authorized personnel operate the vehicles, adding an additional layer of security through cross-referencing driver identities with registered vehicle information. The system 202 also plays a vital role in rapid response and emergency assistance. In emergency situations or accidents, the system 202 may quickly pinpoint the location of incidents and relay critical information to emergency services, enabling prompt assistance for those in need. Additionally, the data collected by the system 202 can be analyzed to identify patterns of suspicious activities and potential vulnerabilities, helping to improve security protocols proactively.

Further, integration with existing security infrastructure, such as surveillance cameras, GPS tracking devices, and alarm systems, creates a comprehensive security ecosystem that provides a holistic view of fleet safety. The system's data can also be utilized to generate reports that comply with regulatory requirements for vehicle security and safety standards. For organizations that operate large fleets, the Vehicle SOC serves as a centralized facility responsible for monitoring and managing security. The SOC integrates with the system 202 to track and oversee vehicle security and operational efficiency. This integration enhances the safety of drivers, passengers, and cargo. In the event of accidents, the system 202 offers valuable insights into the movements of involved vehicles, assisting law enforcement and insurance investigators in accurately reconstructing events and determining liability. As adoption of the system 202 increases, it is expected to deter the incidence of cloned license plates. Additionally, traffic management authorities can analyze collected data to gain insights into traffic patterns, congestion, and hazardous intersections, thereby optimizing traffic flow and enhancing public safety. The system 202 is designed for customization and scalability, allowing it to be tailored to meet the specific needs of various clients while adapting to the size and requirements of different deployment areas.

The present disclosure has multiple advantages. For example, the system 202 employs the geo-location disparity factor to evaluate the similarity between the two vehicles, which significantly improves precision in matching license plates and detecting potential vehicle cloning. Additionally, the system 202 operates independently of predefined traversed paths or directional tracking, allowing it to identify vehicle cloning effectively in single detection scenarios across diverse conditions. A notable feature is the system's ability to calculate the confidence score and likelihood of nefarious activities, enabling the establishment of customizable trigger-based thresholds. This flexibility permits timely and appropriate remedial actions based on varying levels of detected confidence score. Furthermore, by analyzing data from multiple locations and considering time intervals, the system 202 can identify anomalies indicative of vehicle cloning, thereby enhancing the robustness of its overall vehicle cloning determination capabilities. Further, the one or more data capturing devices 208 associated with the system 202 can capture license plate information in real-time as vehicles pass by or are parked. This captured data can be utilized for various applications, including traffic management, toll collection, parking enforcement, and law enforcement, further amplifying the system's value across multiple sectors.

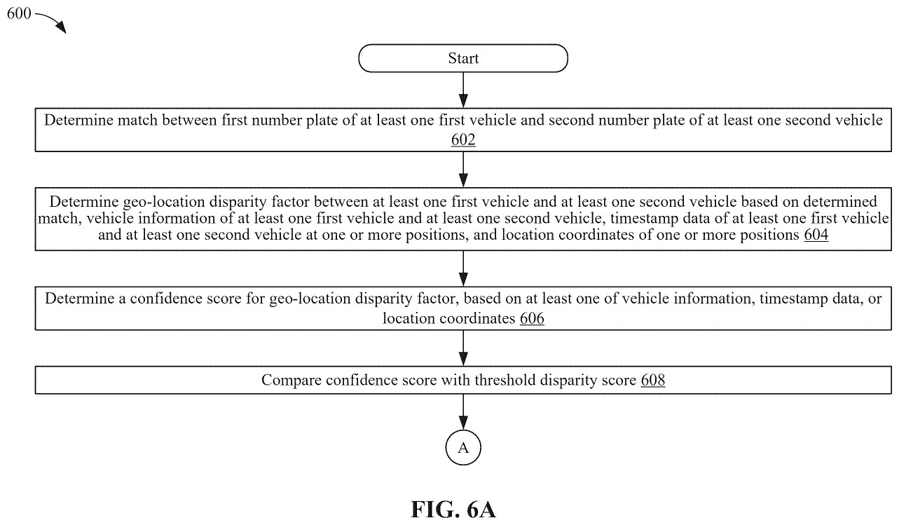

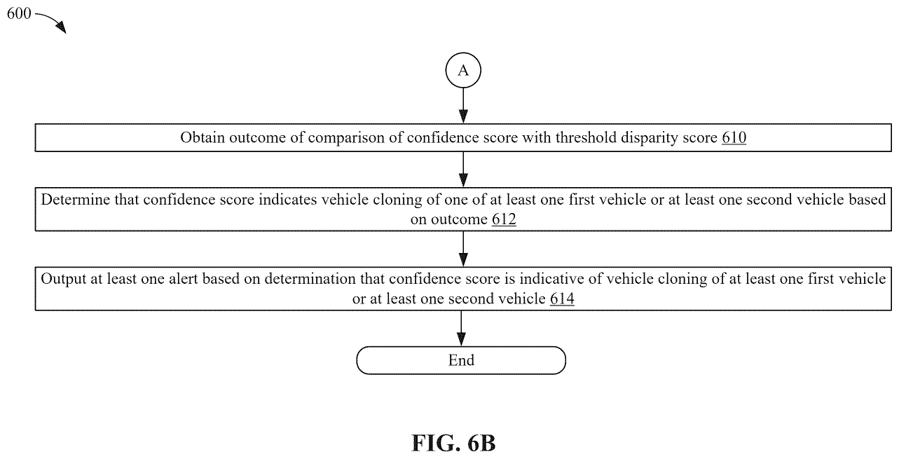

FIG. 6A and FIG. 6B, are diagrams that collectively illustrate a flowchart that illustrates an exemplary first method for the determination of vehicle cloning using the geo-location disparity, in accordance with an embodiment of the disclosure. FIG. 6A and FIG. 6B are explained in conjunction with elements from FIG. 1, FIG. 2, FIG. 3, FIG. 4, and FIG. 5. With reference to FIG. 6A and FIG. 6B, there is shown flowchart 600. The operations of the exemplary method are executed by any computing system, for example, by the computer 102 of FIG. 1 or the system 202 of FIG. 2. The operations of the flowchart 600 may start at 602.

At 602, a match between a first number plate of at least one first vehicle and a second number plate of at least one second vehicle is determined. In an embodiment of the disclosure, the system 202 may be configured to determine the match between a first number plate of at least one first vehicle and a second number plate of at least one second vehicle. Details about the determination of the match are provided, for example, in FIG. 3 and FIG. 5.

At 604, a geo-location disparity factor between the at least one first vehicle and the at least one second vehicle is determined based on the determined match, vehicle information of the at least one first vehicle and the at least one second vehicle, timestamp data of the at least one first vehicle and the at least one second vehicle at one or more positions, and location coordinates of the one or more positions. In an embodiment of the disclosure, the system 202 may be configured to determine the geo-location disparity factor between the at least one first vehicle and the at least one second vehicle based on the determined match, the vehicle information of the at least one first vehicle, and the at least one second vehicle, the timestamp data of the at least one first vehicle and the at least one second vehicle at the one or more positions, the and location coordinates of the one or more positions. Details about the determination of the geo-location disparity are provided, for example, in FIG. 3 and FIG. 4.

At 606, a confidence score for the geo-location disparity factor is determined based on the vehicle information, the timestamp data, the location coordinates, or any combination thereof. In an embodiment of the disclosure, the system 202 may be configured to determine the confidence score for the geo-location disparity factor based on the vehicle information, the timestamp data, the location coordinates, or any combination thereof. Details about the determination of the confidence score are provided, for example, in FIG. 3.

At 608, the confidence score is compared with a threshold disparity score. In an embodiment of the disclosure, the system 202 may be configured to compare the confidence score with the threshold disparity score. Details about the comparison of the confidence score with a threshold disparity score are provided, for example, in FIG. 3.

At 610, an outcome of the comparison of the confidence score with the threshold disparity score is obtained. In an embodiment of the disclosure, the system 202 may be configured to obtain the outcome of the comparison of the confidence score with the threshold disparity score. Details about the outcome of the comparison are provided, for example, in FIG. 3.

At 612, it is determined that the confidence score indicates vehicle cloning of the at least one first vehicle or the at least one second vehicle based on the outcome. In an embodiment of the disclosure, the system 202 may be configured to determine that the confidence score indicates vehicle cloning of the at least one first vehicle or the at least one second vehicle based on the outcome. Details about the indication of vehicle cloning are provided, for example, in FIG. 3.

At 614, at least one alert is output based on the determination that the confidence score is indicative of vehicle cloning of the at least one first vehicle or the at least one second vehicle. In an embodiment of the disclosure, the system 202 may be configured to output the at least one alert based on the determination that the confidence score is indicative of vehicle cloning of the at least one first vehicle or the at least one second vehicle. Details about output of the at least one alert are provided, for example, in FIG. 3.

While the above steps shown in FIG. 6A and FIG. 6B are described in a particular sequence, the steps may occur in variations to the sequence in accordance with various embodiments of the present disclosure. Further, details related to various steps of FIG. 6A and FIG. 6B, which are already covered in the description related to FIG. 1 to FIG. 5 are not discussed again in detail here for the sake of brevity.

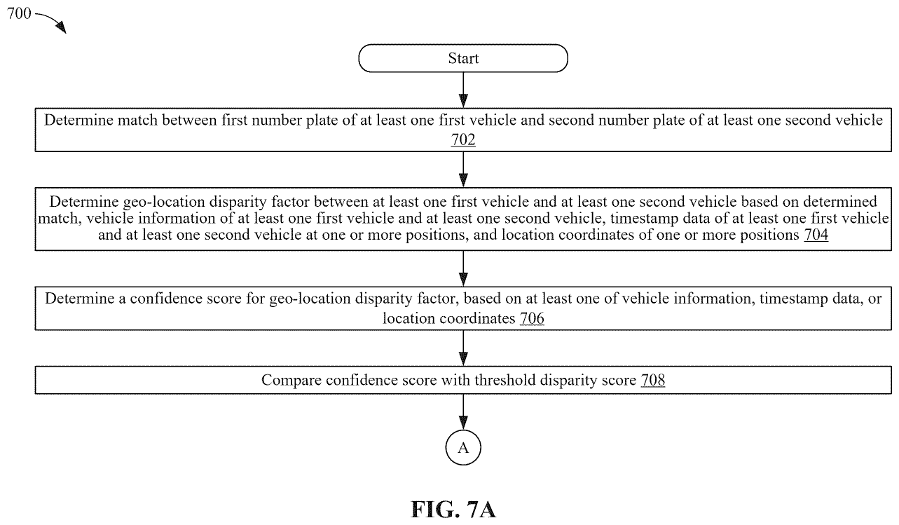

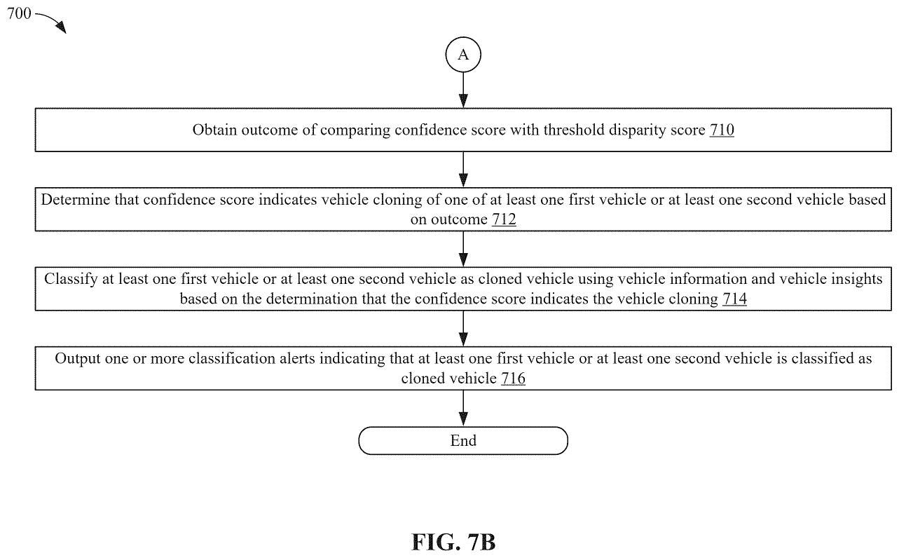

FIG. 7A and FIG. 7B, are diagrams that collectively illustrate a flowchart that illustrates an exemplary second method for the determination of vehicle cloning using the geo-location disparity, in accordance with an embodiment of the disclosure. FIG. 7A and FIG. 7B are explained in conjunction with elements from FIG. 1, FIG. 2, FIG. 3, FIG. 4, FIG. 5, FIG. 6A, and FIG. 6B. With reference to FIG. 7A and FIG. 7B, there is shown flowchart 700. The operations of the exemplary method are executed by any computing system, for example, by the computer 102 of FIG. 1 or the system 202 of FIG. 2. The operations of the flowchart 700 may start at 702.

At 702, a match between a first number plate of at least one first vehicle and a second number plate of at least one second vehicle is determined. In an embodiment of the disclosure, the system 202 may be configured to determine the match between a first number plate of at least one first vehicle and the second number plate of the at least one second vehicle. Details about the determination of the match are provided, for example, in FIG. 3 and FIG. 5.

At 704, a geo-location disparity factor between the at least one first vehicle and the at least one second vehicle is determined based on the determined match, vehicle information of the at least one first vehicle and the at least one second vehicle, timestamp data of the at least one first vehicle and the at least one second vehicle at one or more positions, and location coordinates of the one or more positions. In an embodiment of the disclosure, the system 202 may be configured to determine the geo-location disparity factor between the at least one first vehicle and the at least one second vehicle on the determined match, the vehicle information of the at least one first vehicle and the at least one second vehicle, the timestamp data of the at least one first vehicle and the at least one second vehicle at one or more positions, and the location coordinates of the one or more positions. Details about the determination of the geo-location disparity are provided, for example, in FIG. 3 and FIG. 4.

At 706, a confidence score for the geo-location disparity factor is determined based on the vehicle information, the timestamp data, the location coordinates, or any combination thereof. In an embodiment of the disclosure, the system 202 may be configured to determine the confidence score for the geo-location disparity factor based on the vehicle information, the timestamp data, the location coordinates, or any combination thereof. Details about the determination of the confidence score are provided, for example, in FIG. 3.

At 708, the confidence score is compared with a threshold disparity score. Details about the comparison of the confidence score with a threshold disparity score are provided, for example, in FIG. 3.

At 710, an outcome of the comparison of the confidence score with the threshold disparity score is obtained. In an embodiment of the disclosure, the system 202 may be configured to obtain the outcome of the comparison of the confidence score with the threshold disparity score. Details about the outcome of the comparison are provided, for example, in FIG. 3.

At 712, it is determined that the confidence score indicates vehicle cloning of the at least one first vehicle or the at least one second vehicle based on the outcome. In an embodiment of the disclosure, the system 202 may be configured to determine that the confidence score indicates vehicle cloning of the at least one first vehicle or the at least one second vehicle based on the outcome. If the confidence score is above the threshold disparity score, it indicates the vehicle cloning, prompting the system 202 to trigger further investigative actions and alert relevant authorities. If the confidence score is below the threshold, it indicates that the vehicles are likely legitimate and no cloning activity is suspected, leading to a conclusion that no further action is needed. When the confidence score is equal to the threshold, it may warrant additional scrutiny, as this represents an ambiguous situation where further analysis or data collection may be required to clarify the potential for cloning. Details about the indication of vehicle cloning are provided, for example, in FIG. 3.

At 714, the at least one first vehicle or the at least one second vehicle is classified as a cloned vehicle using the vehicle information and vehicle record data based on the determination that the confidence score indicates the vehicle cloning. In an embodiment of the disclosure, the system 202 may be configured to classify the at least one first vehicle or the at least one second vehicle as a cloned vehicle based on the vehicle information and the vehicle record data based on the determination that the confidence score indicates the vehicle cloning. For classifying the at least one first vehicle or the at least one second vehicle as the cloned vehicle, the vehicle's license plate details, registration data, and any discrepancies in geo-location patterns may be analyzed. Additionally, the historical data related to the vehicle's movements and any reported anomalies may be evaluated to enable a comprehensive assessment that confirms the likelihood of the vehicle cloning. Details about the classification of the at least one first vehicle or the at least one second vehicle are provided, for example, in FIG. 3.

At 716, one or more classification alerts indicating that the at least one first vehicle or the at least one second vehicle is classified as the cloned vehicle are output. In an embodiment of the disclosure, the system 202 may be configured to output the one or more classification alerts indicating that the at least one first vehicle or the at least one second vehicle is classified as the cloned vehicle. Details about output of the one or more classification alerts are provided, for example, in FIG. 3.

While the above steps shown in FIG. 7A and FIG. 7B are described in a particular sequence, the steps may occur in variations to the sequence in accordance with various embodiments of the present disclosure. Further, details related to various steps of FIG. 7A and FIG. 7B, which are already covered in the description related to FIG. 1 to FIG. 6B are not discussed again in detail here for the sake of brevity.

Various embodiments of the disclosure may provide a computer-program product for vehicle cloning determination using geo-location disparity. The computer-program product comprises one or more computer-readable storage media and program instructions stored on the one or more computer-readable storage media to perform operations. The operation includes determining a match between a first number plate of at least one first vehicle and a second number plate of at least one second vehicle. Further, the operation includes determining a geo-location disparity factor between the at least one first vehicle and the at least one second vehicle based on the determined match, vehicle information of the at least one first vehicle and the at least one second vehicle, timestamp data of the at least one first vehicle and the at least one second vehicle at one or more positions, and location coordinates of the one or more positions. Furthermore, the operation includes determining a confidence score for the geo-location disparity factor based on the vehicle information, the timestamp data, the location coordinates, or any combination thereof. The operation also includes comparing the confidence score with a threshold disparity score. Further, the operation includes obtaining an outcome of the comparison of the confidence score with the threshold disparity score. The operation includes determining that the confidence score indicates vehicle cloning of the at least one first vehicle or the at least one second vehicle based on the outcome. The operation also includes outputting at least one alert based on the determination that the confidence score is indicative of vehicle cloning of the at least one first vehicle or the at least one second vehicle.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
determining, by a computer, a match between a first number plate of at least one first vehicle and a second number plate of at least one second vehicle;
determining, by the computer, a geo-location disparity factor between the at least one first vehicle and the at least one second vehicle based on the determined match, vehicle information of the at least one first vehicle and the at least one second vehicle, timestamp data of the at least one first vehicle and the at least one second vehicle at one or more positions, and location coordinates of the one or more positions;
determining, by the computer, a confidence score for the geo-location disparity factor, based on at least one of the vehicle information, the timestamp data, or the location coordinates;
comparing, by the computer, the confidence score with a threshold disparity score;
obtaining, by the computer, an outcome of the comparison of the confidence score with the threshold disparity score;
determining, by the computer, that the confidence score indicates vehicle cloning of one of the at least one first vehicle or the at least one second vehicle based on the outcome; and
outputting, by the computer, at least one alert based on the determination that the confidence score is indicative of vehicle cloning of one of the at least one first vehicle or the at least one second vehicle.

2. The computer-implemented method of claim 1, further comprising:
receiving, by the computer, a set of images of the at least one first vehicle and the at least one second vehicle from one or more data capturing devices, wherein the one or more data capturing devices are positioned at a set of locations;
detecting, by the computer, the first number plate and the second number plate in the set of images;
detecting, by the computer, a first image of the first number plate and a second image of the second number plate in the set of images;
segmenting, by the computer, the first image and the second image from the set of images;
executing, by the computer, an Optical Character Recognition (OCR) process on the first image to extract a first set of characters from the first number plate using a first set of parameters, wherein the first set of characters is extracted based on the segmentation of the first image, and wherein the first set of parameters comprises at least one of a font of the first set of characters, a size of the first set of characters, an angle of the first set of characters, or lighting conditions of the first set of characters in the first number plate;
executing, by the computer, the OCR process on the second image to extract a second set of characters from the second number plate using a second set of parameters, wherein the second set of characters is extracted based on the segmentation of the second image, and wherein the second set of parameters comprises at least one of a font of the second set of characters, a size of the second set of characters, an angle of the second set of characters, or lighting conditions of the second set of characters in the second number plate;
comparing, by the computer, the first set of characters with the second set of characters using one of a Machine Learning (ML) model or fuzzy matching; and
determining, by the computer, the match between the first number plate and the second number plate based on the comparison of the first set of characters with the second set of characters.

3. The computer-implemented method of claim 1, further comprising:
determining, by the computer, a difference between the location coordinates of the at least one first vehicle and the location coordinates of the at least one second vehicle while the at least one first vehicle and the at least one second vehicle are moving through the one or more positions; and
determining, by the computer, the geo-location disparity factor between the at least one first vehicle and the at least one second vehicle based on the difference between the location coordinates of the at least one first vehicle and the at least one second vehicle, the timestamp data, and the vehicle information, wherein the geo-location disparity factor corresponds to a composite metric that quantitatively assesses spatial and temporal discrepancies between the at least one first vehicle and the at least one second vehicle.

4. The computer-implemented method of claim 1, further comprising:
generating, by the computer, the threshold disparity score based on the vehicle information, the timestamp data, the location coordinates of the one or more positions, and vehicle record data, wherein the threshold disparity score corresponds to a value that indicates a maximum level of geographic discrepancy between the location coordinates of the at least one first vehicle and the at least one second vehicle over time; and
comparing, by the computer, the confidence score with the generated threshold disparity score.

5. The computer-implemented method of claim 4, wherein the vehicle record data comprises at least one of vehicle history reports of the at least one first vehicle and the at least one second vehicle, spatial maps of the at least one first vehicle and the at least one second vehicle, insurance records of the at least one first vehicle and the at least one second vehicle, registration records of the at least one first vehicle and the at least one second vehicle, permitted speed limits at the one or more positions, weather data of the one or more positions, traffic data of the one or more positions, Department of Motor Vehicles (DMV) records of the at least one first vehicle and the at least one second vehicle, or service records of the at least one first vehicle and the at least one second vehicle, and wherein the one or more positions correspond to specific locations where one or more data capture devices capture a set of images of the at least one first vehicle and the at least one second vehicle.

6. The computer-implemented method of claim 1, further comprising:
determining, by the computer, that the confidence score for the geo-location disparity factor exceeds the threshold disparity score based on the outcome of the comparison.

7. The method of claim 6, further comprising:
determining, by the computer, that the confidence score indicates the vehicle cloning of the one of the at least one first vehicle or the at least one second vehicle based on the determination that the confidence score for the geo-location disparity factor exceeds the threshold disparity score.

8. The computer-implemented method of claim 1, further comprising:
comparing, by the computer, the vehicle information of the at least one first vehicle and the at least one second vehicle with vehicle record data based on the determination that the confidence score indicates the vehicle cloning;
classifying, by the computer, one of the at least one first vehicle or the at least one second vehicle as a cloned vehicle based on a result of comparison of the vehicle information of the at least one first vehicle and the at least one second vehicle with the vehicle record data; and
generating, by the computer, one or more classification alerts to notify law enforcement authorities that one of the at least one first vehicle or the at least one second vehicle is classified as the cloned vehicle.

9. The computer-implemented method of claim 1, wherein the vehicle information comprises at least one of a license plate number of the at least one first vehicle and the at least one second vehicle, a brand of the at least one first vehicle and the at least one second vehicle, a model of the at least one first vehicle and the at least one second vehicle, an year of manufacture of the at least one first vehicle and the at least one second vehicle, a color of the at least one first vehicle and the at least one second vehicle, a Vehicle Identification Number (VIN) of the at least one first vehicle and the at least one second vehicle, an engine type of the at least one first vehicle and the at least one second vehicle, a fuel type of the at least one first vehicle and the at least one second vehicle, interior features of the at least one first vehicle and the at least one second vehicle, exterior features of the at least one first vehicle and the at least one second vehicle, registration details of the at least one first vehicle and the at least one second vehicle, or an insurance status of the at least one first vehicle and the at least one second vehicle.

10. The computer-implemented method of claim 1, further comprising:
tracking, by the computer, data associated with one or more activities of the at least one first vehicle and the at least one second vehicle based on the vehicle information and the timestamp data; and
outputting, by the computer, the data associated with the one or more activities to law enforcement authorities based on a result of the tracking of the data.

11. A computer system, comprising:
a processor set;
one or more computer-readable storage media; and
program instructions stored on the one or more computer-readable storage media, the program instructions executable by the processor set to cause the processor set to:
determine a match between a first number plate of at least one first vehicle and a second number plate of at least one second vehicle;
determine a geo-location disparity factor between the at least one first vehicle and the at least one second vehicle based on the determined match, vehicle information of the at least one first vehicle and the at least one second vehicle, timestamp data of the at least one first vehicle and the at least one second vehicle at one or more positions, and location coordinates of the one or more positions;
determine a confidence score for the geo-location disparity factor based on at least one of the vehicle information, the timestamp data, or the location coordinates;
compare the confidence score with a threshold disparity score;
obtain an outcome of the comparison of the confidence score with the threshold disparity score;
determine that the confidence score indicates vehicle cloning of one of the at least one first vehicle or the at least one second vehicle based on the outcome;
classify one of the at least one first vehicle or the at least one second vehicle as a cloned vehicle using the vehicle information and vehicle record data based on the determination that the confidence score indicates the vehicle cloning; and
output one or more classification alerts indicating that one of the at least one first vehicle or the at least one second vehicle is classified as the cloned vehicle.

12. The computer system of claim 11, wherein the vehicle record data comprises at least one of vehicle history reports of the at least one first vehicle and the at least one second vehicle, spatial maps of the at least one first vehicle and the at least one second vehicle, insurance records of the at least one first vehicle and the at least one second vehicle, registration records of the at least one first vehicle and the at least one second vehicle, permitted speed limits at the one or more positions, weather data of the one or more positions, traffic data of the one or more positions, Department of Motor Vehicles (DMV) records of the at least one first vehicle and the at least one second vehicle, or service records of the at least one first vehicle and the at least one second vehicle, and wherein the one or more positions correspond to specific locations where one or more data capture devices capture a set of images of the at least one first vehicle and the at least one second vehicle.

13. The computer system of claim 11, wherein, to determine the match between the first number plate and the second number plate, the program instructions executable by the processor set to cause the processor set to:
receive a set of images of the at least one first vehicle and the at least one second vehicle from one or more data capturing devices, wherein the one or more data capturing devices are positioned at a set of locations;
detect the first number plate and the second number plate in the set of images;
detect a first image of the first number plate and a second image of the second number plate in the set of images;
segment the first image and the second image from the set of images;
execute an Optical Character Recognition (OCR) process on the first image to extract a first set of characters from the first number plate using a first set of parameters, wherein the first set of characters is extracted based on the segmentation of the first image, and wherein the first set of parameters comprises at least one of a font of the first set of characters, a size of the first set of characters, an angle of the first set of characters, or lighting conditions of the first set of characters in the first number plate;
execute the OCR process on the second image to extract a second set of characters from the second number plate using a second set of parameters, wherein the second set of characters is extracted based on the segmentation of the second image, and wherein the second set of parameters comprises at least one of a font of the second set of characters, a size of the second set of characters, an angle of the second set of characters, or lighting conditions of the second set of characters in the second number plate;
compare the first set of characters with the second set of characters using one of a Machine Learning (ML) model or fuzzy matching; and
determine the match between the first number plate and the second number plate based on the comparison of the first set of characters with the second set of characters.

14. The computer system of claim 11, wherein the vehicle information comprises at least one of a license plate number of the at least one first vehicle and the at least one second vehicle, a brand of the at least one first vehicle and the at least one second vehicle, a model of the at least one first vehicle and the at least one second vehicle, an year of manufacture of the at least one first vehicle and the at least one second vehicle, a color of the at least one first vehicle and the at least one second vehicle, a Vehicle Identification Number (VIN) of the at least one first vehicle and the at least one second vehicle, an engine type of the at least one first vehicle and the at least one second vehicle, a fuel type of the at least one first vehicle and the at least one second vehicle, interior features of the at least one first vehicle and the at least one second vehicle, exterior features of the at least one first vehicle and the at least one second vehicle, registration details of the at least one first vehicle and the at least one second vehicle, or an insurance status of the at least one first vehicle and the at least one second vehicle.

15. The computer system of claim 11, wherein the program instructions executable by the processor set to cause the processor set to:
track data associated with one or more activities of the at least one first vehicle and the at least one second vehicle based on the vehicle information and the timestamp data; and
output the data associated with the one or more activities to law enforcement authorities based on a result of tracking the data.

16. A computer-program product for vehicle cloning determination, the computer-program product comprising:
one or more computer-readable storage media; and
program instructions stored on the one or more computer-readable storage media to perform operations comprising:
determining a match between a first number plate of at least one first vehicle and a second number plate of at least one second vehicle;
determining a geo-location disparity factor between the at least one first vehicle and the at least one second vehicle based on the determined match, vehicle information of the at least one first vehicle and the at least one second vehicle, timestamp data of the at least one first vehicle and the at least one second vehicle at one or more positions, and location coordinates of the one or more positions;
determining a confidence score for the geo-location disparity factor based on at least one of the vehicle information, the timestamp data, or the location coordinates;
comparing the confidence score with a threshold disparity score;
obtaining an outcome of the comparison of the confidence score with the threshold disparity score;
determining that the confidence score indicates vehicle cloning of one of the at least one first vehicle or the at least one second vehicle based on the outcome; and
outputting at least one alert based on the determination that the confidence score is indicative of vehicle cloning of one of the at least one first vehicle or the at least one second vehicle.

17. The computer-program product of claim 16, wherein the program instructions stored on the one or more computer-readable storage media perform operations comprising:
comparing the vehicle information of the at least one first vehicle and the at least one second vehicle with vehicle record data based on the determination that the confidence score indicates the vehicle cloning;
classifying one of the at least one first vehicle or the at least one second vehicle as a cloned vehicle based on a result of comparison of the vehicle information of the at least one first vehicle and the at least one second vehicle with the vehicle record data; and
generating one or more classification alerts to notify law enforcement authorities that one of the at least one first vehicle or the at least one second vehicle is classified as the cloned vehicle.

18. The computer-program product of claim 17, wherein the vehicle record data comprises at least one of vehicle history reports of the at least one first vehicle and the at least one second vehicle, spatial maps of the at least one first vehicle and the at least one second vehicle, insurance records of the at least one first vehicle and the at least one second vehicle, registration records of the at least one first vehicle and the at least one second vehicle, permitted speed limits at the one or more positions, weather data of the one or more positions, traffic data of the one or more positions, Department of Motor Vehicles (DMV) records of the at least one first vehicle and the at least one second vehicle, or service records of the at least one first vehicle and the at least one second vehicle, and wherein the one or more positions correspond to specific locations where one or more data capture devices capture a set of images of the at least one first vehicle and the at least one second vehicle.

19. The computer-program product of claim 16, wherein the vehicle information comprises at least one of a license plate number of the at least one first vehicle and the at least one second vehicle, a brand of the at least one first vehicle and the at least one second vehicle, a model of the at least one first vehicle and the at least one second vehicle, an year of manufacture of the at least one first vehicle and the at least one second vehicle, a color of the at least one first vehicle and the at least one second vehicle, a Vehicle Identification Number (VIN) of the at least one first vehicle and the at least one second vehicle, an engine type of the at least one first vehicle and the at least one second vehicle, a fuel type of the at least one first vehicle and the at least one second vehicle, interior features of the at least one first vehicle and the at least one second vehicle, exterior features of the at least one first vehicle and the at least one second vehicle, registration details of the at least one first vehicle and the at least one second vehicle, or an insurance status of the at least one first vehicle and the at least one second vehicle.

20. The computer-program product of claim 16, wherein the program instructions stored on the one or more computer-readable storage media perform operations comprising:
tracking data associated with one or more activities of the at least one first vehicle and the at least one second vehicle based on the vehicle information and the timestamp data; and
outputting the data associated with the one or more activities to law enforcement authorities based on a result of tracking the data.
